(19) United States
(12) Patent Application Publication
(10) Pub. No.: US 2018/0011836 A1
(43) Pub. Date: Jan. 11, 2018

(54) Tibetan Character Constituent Analysis Method, Tibetan Sorting Method And Corresponding Devices

(71) Applicants: Nima Zhaxi, Lhasa City (CN); Wanme Zhaxi, Gonghe Country (CN)

(72) Inventors: Nima Zhaxi, Lhasa City (CN); Wanme Zhaxi, Gonghe Country (CN)

(21) Appl. No.: 15/338,509

(22) Filed: Oct. 31, 2016

(30) Foreign Application Priority Data
Jul. 5, 2016 (CN) 201610528753.9

(51) Int. Cl. G06F 17/27; G06F 17/22

(52) U.S. Cl. CPC G06F 17/2775; G06F 17/274; G06F 17/2223; G06F 17/273

(57) ABSTRACT

The present invention discloses a Tibetan character constituent analysis method, a Tibetan sorting method and corresponding devices, and relates to the field of natural language processing. The present invention is proposed to solve the problem that the existing Tibetan sorting methods have no universality or compatibility, which is inconvenient for the use of automatic computer Tibetan sorting. The technical solution provided by the present invention includes: S10, acquiring a Tibetan text to be analyzed; S20, using Tibetan characters in the Tibetan text as the input of a preset finite state automaton group; and S30, acquiring the constituents of the Tibetan characters according to a target finite state automaton, when the target finite state automaton in the finite state automaton group determines that the Tibetan characters in the Tibetan text are correctly spelled.

### CROSS-REFERENCE TO RELATED APPLICATIONS

This application claims the benefit and priority of Chinese Patent Application No. 201610528753.9 filed Jul. 5, 2016. The entire disclosure of the above application is incorporated herein by reference.

### FIELD

The present invention relates to the field of natural language processing, in particular to a Tibetan character constituent analysis method, a Tibetan sorting method and corresponding devices.

### BACKGROUND

Like other languages, automatic computer Tibetan sorting method is also widely used in various fields of Tibetan information technology, including Tibetan dictionary and thesaurus sorting, information retrieval, text sorting and the like. Since the research on the Tibetan information technology in the early 1980s, the research on the automatic computer Tibetan sorting has never been stopped. With the development of the Tibetan information technology, an automatic Tibetan sorting algorithm is generally adopted in the prior art to sort the Tibetan.

However, as the existing sorting algorithms and models are not perfect and are error-prone and too complicated, the existing Tibetan sorting methods have no universality or compatibility, which is inconvenient for the use of the automatic computer Tibetan sorting.

### SUMMARY

The present invention provides a Tibetan character constituent analysis method, a Tibetan sorting method and corresponding devices, which have universality and compatibility, and can facilitate the use of automatic computer Tibetan sorting.

On one aspect, a Tibetan character constituent analysis method is provided, including: S10, acquiring a Tibetan text to be analyzed; S20, using Tibetan characters in the Tibetan text as the input of a preset finite state automaton group; and S30, acquiring the constituents of the Tibetan characters according to a target finite state automaton, when the target finite state automaton in the finite state automaton group determines that the Tibetan characters in the Tibetan text are correctly spelled; the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the [symbol] is a positive integer, and [symbol] ≦24.

On another aspect, a Tibetan sorting method is provided, including: S10, acquiring at least two Tibetan characters to be sorted; S20, respectively using the at least two Tibetan characters to be sorted as the input of a preset finite state automaton group; S30, acquiring the constituents of the Tibetan characters according to a target finite state automaton, when the target finite state automaton in the finite state automaton group determines that the input Tibetan characters are correctly spelled; and S40, sorting the at least two Tibetan characters according to the constituents of the at least two Tibetan characters to acquire a sorting result; the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

On a third aspect, a Tibetan sorting method is provided, including: S10, acquiring at least two Tibetan words to be sorted; S20, respectively acquiring Tibetan characters in the at least two Tibetan words; S30, respectively using the Tibetan characters in the at least two Tibetan words as the input of a preset finite state automaton group; S40, acquiring the constituents of the Tibetan characters according to a target finite state automaton, when the target finite state automaton in the finite state automaton group determines that the input Tibetan characters are correctly spelled; and S50, sorting the at least two Tibetan words according to the constituents of the each Tibetan character in the at least two Tibetan words to acquire a sorting result; the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

On a fourth aspect, a Tibetan character constituent analysis device is provided, including:

a text acquisition module, used for acquiring a Tibetan text to be analyzed;

a text input module, connected with the text acquisition module and used for using Tibetan characters in the Tibetan text as the input of a preset finite state automaton group; and

a constituent analysis module, connected with the text input module and used for acquiring the constituents of the Tibetan characters according to a target finite state automaton, when the target finite state automaton in the finite state automaton group determines that the Tibetan characters in the Tibetan text are correctly spelled;

the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

On a fifth aspect, a Tibetan sorting device is provided, including:

a Tibetan character acquisition module, used for acquiring at least two Tibetan characters to be sorted;

a Tibetan character input module, connected with the Tibetan character acquisition module and used for respectively using the at least two Tibetan characters to be sorted as the input of a preset finite state automaton group;

a constituent analysis module, connected with the Tibetan character input module and used for acquiring the constituents of the Tibetan characters according to a target finite state automaton, when the target finite state automaton in the finite state automaton group determines that the input Tibetan characters are correctly spelled; and

a sorting module, connected with the constituent analysis module and used for sorting the at least two Tibetan characters according to the constituents of the at least two Tibetan characters to acquire a sorting result;

the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton M; qᵢεQᵢ; the Fᵢ represents a finite set of termination states of the finite state automaton Mᵢ and Fᵢ⊂Qᵢ; and the [symbol] is a positive integer, and [symbol] ≦24.

On a sixth aspect, a Tibetan sorting device is provided, including:

a Tibetan word acquisition module, used for acquiring at least two Tibetan words to be sorted;

a Tibetan character acquisition module, connected with the Tibetan word acquisition module and used for respectively acquiring Tibetan characters in the at least two Tibetan words;

a Tibetan character input module, connected with the Tibetan character acquisition module and used for respectively using the Tibetan characters in the at least two Tibetan words as the input of a preset finite state automaton group;

a constituent analysis module, connected with the Tibetan character input module and used for acquiring the constituents of the Tibetan characters according to a target finite state automaton, when the target finite state automaton in the finite state automaton group determines that the input Tibetan characters are correctly spelled; and

a sorting module, connected with the constituent analysis module and used for sorting the at least two Tibetan words according to the constituents of the each Tibetan character in the at least two Tibetan words to acquire a sorting result;

the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention can solve the problem that the existing Tibetan sorting methods have no universality or compatibility, which is inconvenient for the use of automatic computer Tibetan sorting.

### DRAWINGS

FIG. 1 is a flowchart of a Tibetan character constituent analysis method provided by a first embodiment of the present invention;

FIG. 2 is a flowchart of a Tibetan sorting method provided by a second embodiment of the present invention;

FIG. 3 is a flowchart of a Tibetan sorting method provided by a third embodiment of the present invention;

FIG. 4 is a schematic diagram of a structure of a Tibetan character constituent analysis device provided by a fourth embodiment of the present invention;

FIG. 5 is a schematic diagram of a structure of a Tibetan sorting device provided by a fifth embodiment of the present invention;

FIG. 6 is a schematic diagram of a structure of a Tibetan sorting device provided by a sixth embodiment of the present invention.

### DETAILED DESCRIPTION

The present invention will be further illustrated below in combination with accompanying drawings and embodiments. But the usage and the objective of these exemplary implementations are merely used for citing the present invention, but do not constitute any form of limitation to the actual protection scope of the present invention, let alone limit the protection scope of the present invention hereto.

### First Embodiment

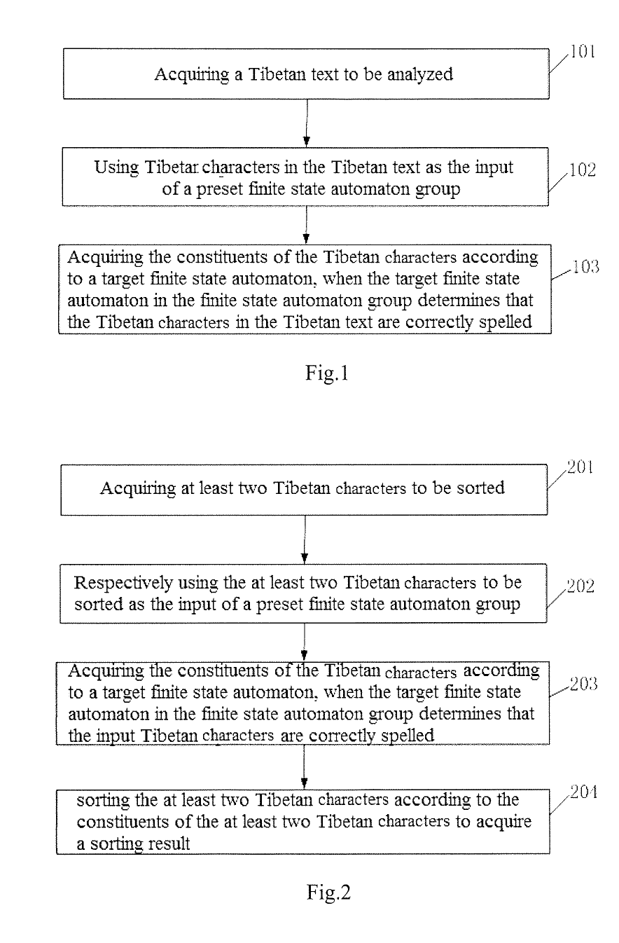

As shown in FIG. 1, the embodiment of the present invention provides a Tibetan character constituent analysis method, including the following steps.

Step 101, a Tibetan text to be analyzed is acquired.

In the embodiment, the Tibetan text acquired in the step 101 can only contain one Tibetan character and can also contain a plurality of Tibetan characters, and this is not limited herein. Specifically, when the Tibetan text contains a plurality of Tibetan characters, the acquired Tibetan text can be firstly segmented with an character as a unit to acquire at least one Tibetan character; and the segmentation mode can be that the acquired Tibetan text is segmented with an character as a unit according to a Tibetan character separator, a vertical character, a double-vertical character and a space character.

Particularly, when the Tibetan text contains a plurality of Tibetan characters, it may also be a Tibetan word composed of a plurality of Tibetan characters, at this time, the acquired Tibetan text can be segmented according to a specific separator and other signs, and this is not limited herein.

Step 102, the Tibetan characters in the Tibetan text are used as the input of a preset finite state automaton group.

In the embodiment, when the Tibetan text only contains one Tibetan character, the step 102 specifically includes: using the Tibetan character as the input of the preset finite state automaton group; and when the Tibetan text only contains a plurality of Tibetan characters, the step 102 specifically includes: respectively using the Tibetan characters in the Tibetan text as the input of the preset finite state automaton group.

In the embodiment, the finite state automaton group includes 24 finite state automata, wherein any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

In the embodiment, 24 Tibetan spelling formal grammars are preset, and each Tibetan spelling formal grammar corresponds to one finite state automaton; and at least one Tibetan character is used as the input of each preset finite state automaton in sequence. The finite set of the terminal symbols of the Tibetan spelling formal grammar Gᵢ is a subset of a set L consisting of 30 Tibetan consonants, 5 reverse scripts, 4 vowel symbols and 1 long vowel symbol, and includes characters (symbols) actually occurring in a sentence (a Tibetan character belonging to a certain structure) of the language; the set of the non-terminal symbols of the Tibetan spelling formal grammar Gᵢ includes words that do not actually occur in the sentence of the language, but play the function of variables in deduction, and are equivalent to the grammatical category in the language. For example, the non-terminal symbol can be a variable of an SVO (Subject Verb Object) word order of the Chinese, the SOV (Subject Object Verb) word order of the Tibetan and other grammars, but it does not occur in a specific sentence, that is, it implicitly works, but cannot be seen.

Elements in the finite set of the terminal symbols and the finite set of the non-terminal symbols correspond to specific Tibetan spelling formal grammars. The initial state of the finite state automaton Mᵢ is a state, in which the automation just starts to work, and this state is a state in which the automaton primarily receives input characters; and the termination state refers to a final state of the automaton. Specifically, the automata in the finite state automaton group can be a determined type and can also be an undetermined type; and to facilitate the understanding and improve the implementation efficiency, the automata of the determined types provided by the embodiment are taken as an example for illustration.

In the embodiment, the process of acquiring the finite state automaton group can include: acquiring the Tibetan spelling formal grammar Gᵢ, wherein the Gᵢ=(Tᵢ, Vᵢ, Sᵢ, Pᵢ); acquiring a termination state identifier Eᵢ of the finite state automaton group Mᵢ; judging whether a finite set Pᵢ of production rules of the Tibetan spelling formal grammar Gᵢ contains a production rule Sᵢ→ [symbol] ; if so, acquiring Fᵢ with values of Sᵢ and Eᵢ; if not, acquiring Fᵢ with a value Eᵢ; and acquiring the finite state automaton Mᵢ according to the Tᵢ, Vᵢ, Sᵢ and Fᵢ, wherein Tᵢ represents the finite set of the terminal symbols of the Tibetan spelling formal grammar Gᵢ; Sᵢ represents a start symbol of the Tibetan spelling formal grammar Gᵢ; SᵢεVᵢ; [symbol] represents a null character; and a finite set Σᵢ of the input characters of the finite state automaton Mᵢ is equivalent to the finite set Tᵢ of the terminal symbols of the Tibetan spelling formal grammar Gᵢ; and the initial state qᵢ of the finite state automaton Mᵢ is equivalent to the start symbol Sᵢ of the Tibetan spelling formal grammar Gᵢ.

Wherein, the process of acquiring the Tibetan spelling formal grammar includes: acquiring the finite set Tᵢ of the terminal symbols, wherein Tᵢ is a subset of the set L, and the set L includes 30 Tibetan consonants, 5 reverse scripts, 4 vowel symbols and 1 long vowel symbol; acquiring the finite set Vᵢ of the non-terminal symbols; acquiring the start symbol Sᵢ, wherein SᵢεVᵢ; acquiring the finite set Pᵢ of the production rules; and acquiring the corresponding Tibetan spelling formal grammar Gᵢ according to the Tᵢ, Vᵢ, Sᵢ and Pᵢ. Wherein, the process of acquiring the finite set Pᵢ of the production rules can include: at first, acquiring a preset Tibetan spelling grammar formal description system; and then acquiring the finite set Pᵢ of the production rules according to the Tibetan spelling grammar formal description system.

In the embodiment, the preset Tibetan spelling grammar formal description system can be established according to a set theory method, and the specific form is as follows:

Tibetan spelling grammar 1: elements in a set Root={b₁, b₂, b₃, b₄, b₅, . . . , b₃₀, b₃₁, b₃₁, b₃₁, b₃₄, b₃₅} respectively correspond to 30 Tibetan consonants and 5 Tibetan reverse scripts, and then any Tibetan character corresponding to bᵢε Root can constitute a root of a Tibetan character.

Tibetan spelling grammar 2: for a set Prefix={b₃, b11, b15, b16, b23}, Prefix⊂Root, any Tibetan character corresponding to bᵢε Prefix, (j=3, 11, 15, 16, 23) can constitute a prefix of the Tibetan character.

Tibetan spelling grammar 3: for a set Suffix={b₃, b₄, b₁₁, b₁₂, b₁₅, b₁₆, b₂₃, b₂₅, b₂₆, b₂₈}, Suffix⊂Root, any Tibetan character corresponding to bᵢεSuffix, (j=3, 4, 11, 12, 15, 16, 23, 25, 26, 28) can constitute a suffix of the Tibetan character.

Tibetan spelling grammar 4: for a set Postfix={b₁₁, b28}, Postfix⊂Suffix⊂Root, any Tibetan character corresponding to bᵢεPostfix, (j=11, 28) can constitute a postfix of the Tibetan character.

Tibetan spelling grammar 5: for a set Superfix={b₂₅, b26, b28}, Superfix⊂Root, any Tibetan character corresponding to bᵢεSuperfix, (j=25, 26, 28) can constitute a superfix of the Tibetan character.

Tibetan spelling grammar 6: for a set Subfix={b₂₀, b₂₄, b₂₅, b₂₆}, Subfix⊂Root, any Tibetan character corresponding to bᵢεSubfix, (j=20, 24, 25, 26) can constitute a subfix of the Tibetan character.

Tibetan spelling grammar 7: for a set Vowel=Vowel₁{a}, Vowel₁={i, u, e, o} corresponds to 4 Tibetan vowel characters, and a represents a Tibetan long vowel character. The Tibetan roots corresponding to bⱼεRoot, (j=1, 23, 5, 7, . . . , 33, 34, 35) can be spelled with vowel characters corresponding to vεVowel, u and a can only be spelled below consonants, and the rest 3 vowel characters can only be spelled above consonants.

Tibetan spelling grammar 8: when the Tibetan roots corresponding to bⱼεRoot, (j=1, 3, 4, 5, 7, 8, 9, 11, 12, 13, 15, 16, 17, 19, 29) are spelled with the superfixes corresponding to bᵢεSuperfix, (i=25, 26, 28), the following grammar rules must be satisfied:

1. bⱼεRoot, (j=1, 3, 4, 7, 8, 9, 11, 12, 15, 16, 17, 19) can only be spelled with b₂₅εSuperfix.

2. bⱼεRoot, (j=1, 3, 4, 5, 7, 9, 11, 13, 15, 29) can only be spelled with b₂₆εSuperfix.

3. bⱼεRoot, (j=1, 3, 4, 8, 9, 11, 12, 13, 15, 16, 17) can only be spelled with b₂₈εSuperfix.

Tibetan spelling grammar 9: when the Tibetan roots corresponding to bⱼεRoot, (j=1, 2, 3, 8, 9, 10, 11, 13, 14, 15, 16, 18, 21, 22, 25, 26, 27, 28, 29) are spelled with the subfixes corresponding to bᵢεSubfix, (i=20, 24, 25, 26), the following grammar rules must be satisfied:

1. bⱼεRoot, (j=1, 2, 3, 8, 11, 18, 21, 22, 25, 26, 27, 29) can only be spelled with b₂₀εSubfix.

2. bⱼεRoot, (j=1, 2, 3, 13, 14, 15, 16) can only be spelled with b₂₄εSubfix.

3. bⱼεRoot, (j=1, 2, 3, 9, 10, 11, 13, 14, 15, 16, 28, 29) can only be spelled with b₂₅εSubfix.

4. bⱼεRoot, (j=1, 3, 15, 22, 25, 28) can only be spelled with b₂₆εSubfix.

5. bⱼεRoot, (j=29) can only be spelled with b₁₄εSubfix.

(Note: to spell the [f] phonetic symbol in other languages, and b₂₉ and b₁₄ spelling forms occur in the modern Tibetan. According to the traditional Tibetan spelling grammar, b₂₉ cannot be used as the superfix, and b₁₄ cannot be used as the subfix either, therefore, as a special condition, when b₂₉ is spelled with b₁₄, b₁₄ is deemed as the “subfix”.)

Tibetan spelling grammar 10: when the Tibetan roots corresponding to bᵢεRoot, (i=1, 3, 12, 13, 15, 16, 17) are simultaneously spelled with the superfixes corresponding to bⱼεSuperfix, (j=25, 28) and the subfixes corresponding to bₖεSubfix, (k=20, 24, 25), the following grammar rules must be satisfied:

1. when being spelled with b₂₅εSuperfix, bᵢεRoot can be simultaneously spelled with b₂₄εSubfix; and when being spelled with b₂₈εSuperfix, bᵢεRoot can be simultaneously spelled with bₖεSubfix, (k=24, 25).

2. When being spelled with b₂₅εSuperfix, b₃εRoot can be simultaneously spelled with b₂₄εSubfix; and when being spelled with b₂₈εSuperfix, b₃εRoot can be simultaneously spelled with bₖεSubfix, (k=24, 25).

3. When being spelled with b₂₈εSuperfix, b₁₂εRoot can be simultaneously spelled with b₂₅εSubfix.

4. When being spelled with b₂₈εSuperfix, b₁₃εRoot can be simultaneously spelled with bₖεSubfix, (k=24, 25).

5. When being spelled with b₂₈εSuperfix, b₁₅εRoot can be simultaneously spelled with bₖεSubfix, (k=24, 25).

6. When being spelled with b₂₅εSuperfix, b₁₆εRoot can be simultaneously spelled with b₂₄εSubfix; and when being spelled with b₂₈εSuperfix, b₁₆εRoot can be simultaneously spelled with bₖεSubfix, (k=24, 25).

7. When being spelled with b₂₅εSuperfix, b₁₇εRoot can be simultaneously spelled with b₂₀εSubfix.

Tibetan spelling grammar 11: when the Tibetan roots corresponding to bᵢεRoot, (i=1, 3, 4, 7, 8, 9, 11, 12, 17, 19) are simultaneously spelled with the prefixes corresponding to b₁₅εPrefix and the superfixes corresponding to bⱼεSuperfix, (j=25, 26, 28), the following grammar rules must be satisfied:

1. bᵢεRoot, (i=1, 3, 4, 7, 8, 9, 11, 12, 17, 19) can be spelled with b₂₅εSuperfix.

2. bᵢεRoot, (i=9,11) can be spelled with b₂₆εSuperfix.

3. bᵢεRoot, (i=1, 3, 4, 8, 9, 11, 12, 17) can be spelled with b₂₈εSuperfix.

Tibetan spelling grammar 12: when the Tibetan roots corresponding to bᵢεRoot, (i=1, 2, 3, 11, 13, 14, 15, 16, 22, 25, 28) are simultaneously spelled with the prefixes corresponding to bᵢεPrefix, (j=11, 15, 16, 23) and the subfixes corresponding to bₖεSubfix, (k=20, 24, 25, 26), the following grammar rules must be satisfied:

1. bᵢεRoot, (i=1, 3, 13, 15, 16) can be spelled with b₁₁εPrefix and b₂₄εSubfix.

2. bᵢεRoot, (i=1, 3, 13, 15) can be spelled with b₁₁εPrefix and b₂₅εSubfix.

3. bᵢεRoot, (i=1, 3) can be spelled with b₁₅εPrefix and b₂₄εSubfix.

4. bᵢεRoot, (i=1, 3, 28) can be spelled with b₁₅εPrefix and b₂₅εSubfix.

5. bᵢεRoot, (i=1, 22, 25, 28) can be spelled with b₁₅εPrefix and b₂₆εSubfix.

6. bᵢεRoot, (i=2, 3) can be spelled with b₁₆εPrefix and bₖεSubfix, (k=24,25).

7. bᵢεRoot, (i=2, 3, 14, 15) can be spelled with b₂₃εPrefix and b₂₄εSubfix.

8. bᵢεRoot, (i=2, 3, 11, 14, 15) can be spelled with b₂₃εPrefix and b₂₅εSubfix.

Tibetan spelling grammar 13: when the Tibetan roots corresponding to bᵢεRoot, (i=1, 3) are spelled with the prefixes corresponding to b₁₅εPrefix, the superfixes corresponding to bⱼ εSuperfix, (i=25, 28) and the subfixes corresponding to bₖεSubfix, (i=24, 25), the following grammar rules must be satisfied:

1. bᵢεRoot, (i=1, 3) can be spelled with b₁₅εPrefix, b₂₅εSuperfix and b₂₄εSubfix.

2. bᵢεRoot, (i=1, 3) can be spelled with b₁₅εPrefix, b₂₈εSuperfix and b₂₅εSubfix.

3. bᵢεRoot, (i=1,3) can be spelled with bᵢₛεPrefix, b₂₈εSuperfix and b₂₄εSubfix.

Tibetan spelling grammar 14: when being spelled with the prefixes corresponding to bⱼεPrefix, (j=3, 11, 15, 16, 23), the Tibetan roots corresponding to bᵢεRoot, (i=1, 2, 3, 4, 5, 6, 7, 8, 9, 10, 11, 12, 13, 14, 15, 16, 17, 18, 19, 21, 22, 24, 27, 28) must be simultaneously spelled with the vowel symbols corresponding to vεVowel, Vowel={i, u, e, o}, or one suffix corresponding to bₖεSuffix, (k=3, 4, 11, 12, 15, 16, 23, 25, 26, 28), and the following grammar rules must be satisfied:

1. bᵢεRoot, (i=5, 8, 9, 11, 12, 17, 21, 22, 24, 27, 28) can only be spelled with b₃εPrefix.

2. bᵢεRoot, (i=1, 3, 4, 13, 15, 16) can only be spelled with b₁₁εPrefix.

3. bᵢεRoot, (i=1, 3, 5, 9, 11, 17, 21, 22, 27, 28) can only be spelled with b₁₅εPrefix.

4. bᵢεRoot, (i=2, 3, 4, 6, 7, 8, 10, 11, 12, 18, 19) can only be spelled with b₁₆εPrefix.

5. bᵢεRoot, (i=2, 3, 6, 7, 10, 11, 14, 15, 18, 19) can only be spelled with b₂₃εPrefix.

Tibetan spelling grammar 15: the Tibetan roots corresponding to bⱼεRoot, (j=1, 2, 3, 4, 5, 6, 7, 8, 9, 10, . . . , 21, 22, 23, 24, 25, 26, 27, 28, 29, 30) can be spelled with any suffix corresponding to bᵢεSuffix, (i=3, 4, 11, 12, 15, 16, 23, 25, 26, 28).

Tibetan spelling grammar 16: the use of the Tibetan postfixes is only related to the suffixes. The Tibetan suffixes corresponding to bᵢεSuffix, (i=3, 4, 12, 15, 16, 25, 26) can be spelled with the postfixes corresponding to bⱼεPostfix, (j=11,28), and the following grammar rules must be satisfied:

1. b₁₁εPostfix can only be spelled with bᵢεSuffix, (i=12, 25, 26).

2. b₂₈εPostfix can only be spelled with bᵢεSuffix, (i=3, 4, 15, 16).

Tibetan spelling grammar 17: when being spelled with the Tibetan subfixes corresponding to bⱼεSubfix, (j=24, 25), the Tibetan roots corresponding to bᵢεRoot, (i=3, 11, 14) can be simultaneously spelled with the Tibetan subfixes corresponding to b₂₀εSubfix. The specific rules are as follows:

1. when being spelled with b₂₅εSubfix, bᵢεRoot, (i=3,11) can be simultaneously spelled with b₂₀εSubfix.

2. When being spelled with b₂₄εSubfix, b₁₄εRoot can be simultaneously spelled with b₂₀εSubfix.

Tibetan spelling grammar 18: the Tibetan consonants corresponding to b₂₉εRoot can be spelled with the Tibetan consonants corresponding to b₁₄εRoot, and b₁₄εRoot is correspondingly located below b₂₉εRoot.

Tibetan spelling grammar 19: when being spelled with the Tibetan consonants corresponding to b₁₄εRoot, the Tibetan consonants corresponding to b₂₉εRoot can be simultaneously spelled with the Tibetan suffixes corresponding to bᵢ εSuffix, (i=3, 4, 11, 12, 15, 16, 23, 25, 26, 28).

Tibetan spelling grammar 20: the Tibetan characters having no suffix can be spelled with the Tibetan consonants corresponding to b₂₃εRoot, and at this time, the Tibetan consonants corresponding to b₂₃εRoot must be spelled with the vowel symbols (i, e, u, o) corresponding to vεVowel, Vowel={i, u, e, o}.

Tibetan spelling grammar 21: besides the special spelling in the grammars 17, 18, 19 and 20, the Tibetan characters are spelled according to the sequence of the prefixes, the superfixes, the roots, the subfixes, the vowel symbols, the suffixes and the postfixes.

In the embodiment, Tᵢ represents the finite set of the terminal symbols of the Tibetan spelling formal grammar Gᵢ; Sᵢ represents the start symbol of the Tibetan spelling formal grammar Gᵢ; SᵢεVᵢ; [symbol] represents a null character; the finite set Σᵢ of the input characters of the finite state automaton Mᵢ is equivalent to the finite set Tᵢ of the terminal symbols of the Tibetan spelling formal grammar Gᵢ; and the initial state qᵢ of the finite state automaton Mᵢ is equivalent to the start symbol Sᵢ of the Tibetan spelling formal grammar Gᵢ. Wherein, Sᵢ represents any possible sentence (it is a Tibetan character in the application herein) in the language L (Gᵢ) generated by the grammar Gᵢ, so Sᵢ is a special non-terminal symbol.

Specifically, the specific forms of the 24 Tibetan spelling formal grammars G₁ to G₂₄ are as follows:

Tibetan spelling formal grammar G₁: the spelling formal grammar G₁ of the Tibetan roots and the vowel symbols is a quadruple (T₁, V₁, S₁, P₁), wherein:

(1) terminal symbol

T₁=T_{B}∪Tₒ, wherein:

T_{B}={b₁, b₂, b₃, b₄, b₅, . . . , b₃₅}, the elements thereof correspond to the Tibetan consonant characters; and Tₒ={i, u, e, o, a}, the elements thereof correspond to the Tibetan vowel characters;

(2) non-terminal symbol set

V₁={S₁, B_{1,1}, B_{1,2}};

(3) S₁ is a non-terminal symbol in V₁ and is a start symbol; and

(4) a production set of the grammar G₁ is: P₁={

S₁→b₁|b₂|b₃|b₄|b₅| . . . |b₃₀|b₃₁|b₃₂|b₃₃|b₃₄|b₃₅,

S₁→b₁B_{1,1}|b₂B_{1,1}|b₃B_{1,1}|b₄B_{1,1}|b₅B_{1,1}| . . . |b₃₀B_{1,1},

S₁→b₃₁B_{1,2}|b₃₂B_{1,2}|b₃₃B_{1,2}|b₃₄B_{1,2}|b₃₅B_{1,2},

B_{1,1}→i|u|e|o|a,

B_{1,2}→i|u|e|o}

With respect to a Tibetan spelling structure 2:

Tibetan spelling formal grammar G₂: the spelling formal grammar G₂ of the Tibetan superfixes, the roots and the vowels is a quadruple (T₂, V₂, S₂, P₂), wherein:

(1) terminal symbol

T₂=T_{B}∪Tₒ, wherein:

T_{B}={b₁, b₃, b₄, b₅, b₇, b₈, b₉, b₁₁, b₁₂, b₁₃, b₁₅, b₁₆, b₁₇, b₁₉, b₂₅, b₂₆, b₂₈, b₂₉}, the elements thereof correspond to the Tibetan consonant characters; and Tₒ={i, u, e, o}, the elements thereof correspond to the Tibetan vowel characters;

(2) non-terminal symbol set

V₂={S₂, B_{2,1}, B_{2,2}, B_{2,3}, B_{2,4}};

(3) S₂ is a non-terminal symbol in V₂ and is the start symbol;

(4) the production set of the grammar G₂ is: P₂={

S₂→b₂₅B_{2,1}|b₂₆B_{2,2}|b₂₈B_{2,3},

B_{2,1}→b₁|b₃|b₄|b₇|b₈|b₉|b₁₁|b₁₂|b₁₅|b₁₆|b₁₇|b₁₉,

B_{2,1}→b₁B_{2,4}|b₃B_{2,4}|b₄B_{2,4}|b₇B_{2,4}|b₈B_{2,4}|b₉B_{2,4}|b₁₁B_{2,4}|b₁₂B_{2,4}|b₁₅B_{2,4}|b₁₆B_{2,4}|b₁₇B_{2,4}|b₁₉B_{2,4},

B_{2,2}→b₁|b₃|b₄|b₅|b₇|b₉|b₁₁|b₁₃|b₁₅|b₂₉,

B_{2,2}→b₁B_{2,4}|b₃B_{2,4}|b₄B_{2,4}|b₅B_{2,4}|b₇B_{2,4}|b₉B_{2,4}|b₁₁B_{2,4}|b₁₃B_{2,4}|b₁₅B_{2,4}|b₂₉B_{2,4},

B_{2,3}→b₁|b₃|b₄|b₈|b₉|b₁₁|b₁₂|b₁₃|b₁₅|b₁₆|b₁₇,

B_{2,3}→b₁B_{2,4}|b₃B_{2,4}|b₄B_{2,4}|b₈B_{2,4}|b₉B_{2,4}|b₁₁B_{2,4}|b₁₂B_{2,4}|b₁₃B_{2,4}|b₁₅B_{2,4}|b₁₆B_{2,4}|b₁₇B_{2,4},

B_{2,4}→i|u|e|o}

With respect to a Tibetan spelling structure 3:

Tibetan spelling formal grammar G₃: the spelling formal grammar G₃ of the Tibetan roots, the subfixes and the vowel symbols is a quadruple (T₃, V₃, S₃, P₃), wherein:

(1) terminal symbol

T₃=T_{B}∪Tₒ, wherein:

T_{B}{b₁, b₂, b₃, b₈, b₉, b₁₀, b₁₁, b₁₃, b₁₄, b₁₅, b₁₆, b₁₈, b₂₀, b₂₁, b₂₂, b₂₄, b₂₅, b₂₆, b₂₇, b₂₈, b₂₉}, the elements thereof correspond to the Tibetan consonant characters; and T₀={i, u, e, o}, the elements thereof correspond to the Tibetan vowel characters;

(2) non-terminal symbol set

V₃={S₃, B_{3,1}, B_{3,2}, B_{3,3}, B_{3,4}, B_{3,5}, B_{3,6}, B_{3,7}, B_{3,8}, B_{3,9}, B_{3,10}};

(3) S₃ is a non-terminal symbol in V₃ and is the start symbol; and

(4) the production set of the grammar G₃ is: P₃={

S₃→b₁B_{3,1}|b₃B_{3,1},

S₃→b₂B_{3,2},

S₃→b₁₁B_{3,3}|b₂₉B_{3,3},

S₃→b₈B_{3,4}|b₁₈B_{3,4}|b₂₁B_{3,4}|b₂₆B_{3,4}|b₂₇B_{3,4},

S₃→b₉B_{3,5}|b₁₀B_{3,5},

S₃→b₁₃B_{3,6}|b₁₄B_{3,6}|b₁₆B_{3,6},

S₃→b₂₂B_{3,7}|b₂₅B_{3,7},

S₃→b₂₈B_{3,8},

S₃→b₁₅B_{3,9},

B_{3,1}→b₂₀|b₂₄|b₂₅|b₂₆,

B_{3,1}→b₂₀B_{3,10}|b₂₄B_{3,10}|b₂₅B_{3,10}|b₂₆B_{3,10},

B_{3,2}→b₂₀|b₂₄|b₂₅,

B_{3,2}→b₂₀B_{3,10}|b₂₄B_{3,10}|b₂₅B_{3,10},

B_{3,3}→b₂₀|b₂₅,

B_{3,3}→b₂₀B_{3,10}|b₂₅B_{3,10},

B_{3,4}→b₂₀,

B_{3,4}→b₂₀B_{3,10},

B_{3,5}→b₂₅,

B_{3,5}→b₂₅B_{3,10},

B_{3,6}→b₂₄|b₂₅,

B_{3,6}→b₂₄B_{3,10}|b₂₅B_{3,10},

B_{3,7}→b₂₀|b₂₆,

B_{3,7}→b₂₀B_{3,10}|b₂₆B_{3,10},

B_{3,8}→b₂₅|b₂₆,

B_{3,8}→b₂₅B_{3,10}|b₂₆B_{3,10},

B_{3,9}→b₂₄|b₂₅|b₂₆,

B_{3,9}→b₂₄B_{3,10}|b₂₅B_{3,10}|b₂₆B_{3,10},

B_{3,10}→i|u|e|o}

With respect to a Tibetan spelling structure 4:

Tibetan spelling formal grammar G₄: the spelling formal grammar G₄ of the superfixes, the Tibetan roots, the subfixes and the vowel symbols is a quadruple (T₄, V₄, S₄, P₄, wherein:

(1) terminal symbol

T₄=T_{B}∪Tₒ, wherein T_{B}={b₁, b₃, b₁₂, b₁₃, b₁₅, b₁₆, b₁₇, b₂₀, b₂₄, b₂₅, b₂₈}, the elements thereof correspond to the Tibetan consonant characters; and Tₒ={i, u, e, o}, the elements thereof correspond to the Tibetan vowel characters;

(2) non-terminal symbol set

V₄={S₄, B_{4,1}, B_{4,2}, B_{4,3}, B_{4,4}, B_{4,5}, B_{4,6}B_{4,7}};

(3) S₄ is a non-terminal symbol in V₄ and is the start symbol; and

(4) the production set of the grammar G₄ is: P₄={

S₄→b₂₅B_{4,1},

S₄→b₂₈B_{4,2},

B_{4,1}→b₁B_{4,3}|b₃B_{4,3}|b₁₆B_{4,3},

B_{4,1}→b₁₇B_{4,4},

B_{4,2}→b₁B_{4,5}|b₃B_{4,5}|b₁₃B_{4,5}|b₁₅B_{4,5}|b₁₆B_{4,5},

B_{4,2}→b₁₂B_{4,6},

B_{4,3}→b₂₄,

B_{4,3}→b₂₄B_{4,7},

B_{4,4}→b₂₀,

B_{4,4}→b₂₀B_{4,7},

B_{4,5}→b₂₄|b₂₅,

B_{4,5}→b₂₄B_{4,7}|b₂₅B_{4,7},

B_{4,6}→b₂₅,

B_{4,6}→b₂₅B_{4,7},

B_{4,7}→i|u|e|o}

With respect to a Tibetan spelling structure 5:

Tibetan spelling formal grammar G₅: the spelling formal grammar G₅ of the Tibetan prefixes, the superfixes, the roots and the vowel symbols is a quadruple (T₅, V₅, S₅, P₅), wherein:

(1) terminal symbol

T₅=T_{B}∪Tₒ, wherein:

T_{B}={b₁, b₃, b₄, b₇, b₈, b₉, b₁₁, b₁₂, b₁₅, b₁₇, b₁₉, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₅={S₅, B_{5,1}, B_{5,2}, B_{5,3}, B_{5,4}, B_{5,5}};

(3) S₅ is a non-terminal symbol in V₅ and is the start symbol; and

(4) the production set of the grammar G₅ is: P₅={

S₅→b₁₅B_{5,1},

B_{5,1}→b₂₈B_{5,2},

B_{5,1}→b₂₆B_{5,3},

B_{5,1}→b₂₅B_{5,4},

B_{5,2}→b₁|b₃|b₄|b₈|b₉|b₁₁|b₁₂|b₁₇,

B_{5,2}→b₁B_{5,5}|b₃B_{5,5}|b₄B_{5,5}|b₈B_{5,5}|b₉B_{5,5}|b₁₁B_{5,5}|b₁₂B_{5,5}|b₁₇B_{5,5},

B_{5,3}→b₉|b₁₁,

B_{5,3}→b₉B_{5,5}|b₁₁B_{5,5};

B_{5,4}→b₁|b₃|b₄|b₇|b₈|b₉|b₁₁|b₁₂|b₁₇|b₁₉,

B_{5,4}→b₁B_{5,5}|b₃B_{5,5}|b₄B_{5,5}|b₇B_{5,5}|b₈B_{5,5}|b₉B_{5,5}|b₁₁B_{5,5}|b₁₂B_{5,5}|b₁₇B_{5,5}|b₁₉B_{5,5},

B_{5,5}→i|u|e|o}

With respect to a Tibetan spelling structure 6:

Tibetan spelling formal grammar G₆: the spelling formal grammar G₆ of the Tibetan prefixes, the roots, the subfixes and the vowel symbols is a quadruple (T₆, V₆, S₆, P₆), wherein:

(1) terminal symbol

T₆=T_{B}∪Tₒ, wherein:

T_{B}={b₁, b₂, b₃, b₁₁, b₁₃, b₁₄, b₁₅, b₁₆, b₂₂, b₂₃, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₆={S₆, B_{6,1}, B_{6,2}, B_{6,3}, B_{6,4}, B_{6,5}, B_{6,6}, B_{6,7}, B_{6,8}, B_{6,9}, B_{6,10}, B_{6,11}};

(3) S₆ is a non-terminal symbol in V₆ and is the start symbol; and

(4) the production set of the grammar G₆ is: P₆={

S₆→b₁₁B_{6,1}|b₁₅B_{6,2}|b₁₆B_{6,3}|b₂₃B_{6,4},

B_{6,1}→b₁₆B_{6,5},

B_{6,1}→b₁B_{6,9}|b₃B_{6,9}|b₁₃B_{6,9}|b₁₅B_{6,9},

B_{6,2}→b₁B_{6,6},

B_{6,2}→b₂₂B_{6,7}|b₂₅B_{6,7},

B_{6,2}→b₂₈B_{6,8},

B_{6,2}→b₃B_{6,9},

B_{6,3}→b₂B_{6,9}|b₃B_{6,9},

B_{6,4}→b₂B_{6,9}|b₃B_{6,9}|b₁₄B_{6,9}|b₁₅B_{6,9},

B_{6,4}→b₁₁B_{6,10},

B_{6,5}→b₂₄,

B_{6,5}→b₂₄B_{6,11},

B_{6,6}→b₂₄|b₂₅|b₂₆,

B_{6,6}→b₂₄B_{6,11}|b₂₅B_{6,11}|b₂₆B_{6,11},

B_{6,7}→b₂₆,

B_{6,7}→b₂₆B_{6,11},

B_{6,8}→b₂₅|b₂₆,

B_{6,8}→b₂₅B_{6,11}|b₂₆B_{6,11},

B_{6,9}→b₂₄|b₂₅,

B_{6,9}→b₂₄B_{6,11}|b₂₅B_{6,11},

B_{6,10}→b₂₅,

B_{6,10}→b₂₅B_{6,11},

B_{6,11}→i|u|e|o}

With respect to a Tibetan spelling structure 7:

Tibetan spelling formal grammar G₇: the spelling formal grammar G₇ of the Tibetan prefixes, the superfixes, the roots, the subfixes and the vowel symbols is a quadruple (T₇, V₇, S₇, P₇), wherein:

(1) terminal symbol

T₇=T_{B}∪Tₒ, wherein:

T_{B}={b₁, b₃, b₁₅, b₂₄, b₂₅, b₂₈}, the elements thereof correspond to the Tibetan consonant characters; and Tₒ={i, u, e, o}, the elements thereof correspond to the Tibetan vowel characters;

(2) non-terminal symbol set

V₇{S₇, B_{7,1}, B_{7,2}, B_{7,3}, B_{7,4}, B_{7,5}, B_{7,6}};

(3) S₇ is a non-terminal symbol in V₇ and is the start symbol; and

(4) the production set of the grammar G₇ is: P₇={

S₇→b₁₅B_{7,1},

B_{7,1}→b₂₈B_{7,2},

B_{7,1}→b₂₅B_{7,3},

B_{7,2}→b₁B_{7,4}|b₃B_{7,4},

B_{7,3}→b₁B_{7,5}|b₃B_{7,5},

B_{7,4}→b₂₄|b₂₅,

B_{7,4}→b₂₄B_{7,6}|b₂₅B_{7,6},

B_{7,5}→b₂₄,

B_{7,5}→b₂₄B_{7,6},

B_{7,6}→i|u|e|o}

With respect to a Tibetan spelling structure 8:

Tibetan spelling formal grammar G₈: the spelling formal grammar G₈ of the Tibetan prefixes, the roots and the vowel symbols is a quadruple (T₈, V₈, S₈, P₈), wherein:

(1) terminal symbol

T₈=T_{B}∪Tₒ, wherein:

T_{B}={b₁, b₂, b₃, b₄, b₅, b₆, b₇, b₈, b₉, b₁₀, b₁₁, b₁₂, b₁₃, b₁₄, b₁₅, b₁₆, b₁₇, b₁₈, b₁₉, b₂₁, b₂₂, b₂₃, b₂₄, b₂₇, b₂₈}, the elements thereof correspond to the Tibetan consonant characters; and Tₒ={i, u, e, o}, the elements thereof correspond to the Tibetan vowel characters;

(2) non-terminal symbol set

V₈={S₈, B_{8,1}, B_{8,2}, B_{8,3}, B_{8,4}, B_{8,5}, B_{8,6}};

(3) S₈ is a non-terminal symbol in V₈ and is the start symbol; and

(4) the production set of the grammar G₈ is: P₈={

S₈→b₃B_{8,1}|b₁₁B_{8,2}|b₁₅B_{8,3}|b₁₆B_{8,4}|b₂₃B_{8,5},

B_{8,1}→b₅B_{8,6}|b₈B_{8,6}|b₉B_{8,6}|b₁₁B_{8,6}|b₁₂B_{8,6}|b₁₇B_{8,6}|b₂₁B_{8,6}|b₂₂B_{8,6}|b₂₄B_{8,6}|b₂₇B_{8,6}|b₂₈B_{8,6},

B_{8,2}→b₁B_{8,6}|b₃B_{8,6}|b₄B_{8,6}|b₁₃B_{8,6}|b₁₅B_{8,6}|b₁₆B_{8,6},

B_{8,3}→b₁B_{8,6}|b₃B_{8,6}|b₅B_{8,6}|b₉B_{8,6}|b₁₁B_{8,6}|b₁₇B_{8,6}|b₂₁B_{8,6}|b₂₂B_{8,6}|b₂₇B_{8,6}|b₂₈B_{8,6},

B_{8,4}→b₂B_{8,6}|b₃B_{8,6}|b₄B_{8,6}|b₆B_{8,6}|b₇B_{8,6}|b₈B_{8,6}|b₁₀B_{8,6}|b₁₁B_{8,6}|b₁₂B_{8,6}|b₁₈B_{8,6}|b₁₉B_{8,6},

B_{8,5}→b₂B_{8,6}|b₃B_{8,6}|b₆B_{8,6}|b₇B_{8,6}|b₁₀B_{8,6}|b₁₁B_{8,6}|b₁₄B_{8,6}|b₁₅B_{8,6}|b₁₈B_{8,6}|b₁₉B_{8,6},

B_{8,6}→i|u|e|o}

With respect to a Tibetan spelling structure 9:

Tibetan spelling formal grammar G₉: the spelling formal grammar G₉ of the Tibetan prefixes, the roots, the vowel characters and the suffixes is a quadruple (T₉, V₉, S₉, P₉), wherein:

(1) terminal symbol

T₉=T_{B}∪Tₒ, wherein:

T_{B}={b₁, b₂, b₃, b₄, b₅, b₆, b₇, b₈, b₉, b₁₀, b₁₁, b₁₂, b₁₃, b₁₄, b₁₅, b₁₆, b₁₇, b₁₈, b₁₉, b₂₁, b₂₂, b₂₃, b₂₄, b₂₅, b₂₆, b₂₇, b₂₈}, the elements thereof correspond to the Tibetan consonant characters; and Tₒ={i, u, e, o}, the elements thereof correspond to the Tibetan vowel characters;

(2) non-terminal symbol set

V₉={S₉, B_{9,1}, B_{9,2}, B_{9,3}, B_{9,4}, B_{9,5}, B₉, B_{9,7}};

(3) S₉ is a non-terminal symbol in V₉ and is the start symbol; and

(4) the production set of the grammar G₉ is: P₉={

S₉→b₃B_{9,1}|b₁₁B_{9,2}|b₁₅B_{9,3}|b₁₆B_{9,4}|b₂₃B_{9,5},

B_{9,1}→b₅B_{9,7}|b₈B_{9,7}|b₉B_{9,7}|b₁₁B_{9,7}|b₁₂B_{9,7}|b₁₇B_{9,7}|b₂₁B_{9,7}|b₂₂B_{9,7}|b₂₄B_{9,7}|b₂₇B_{9,7}|b₂₈B_{9,7},

B_{9,1}→b₅B_{9,6}|b₈B_{9,6}|b₉B_{9,6}|b₁₁B_{9,6}|b₁₂B_{9,6}|b₁₇B_{9,6}|b₂₁B_{9,6}|b₂₂B_{9,6}|b₂₄B_{9,6}|b₂₇B_{9,6}|b₂₈B_{9,6},

B_{6,2}→b₁B_{9,7}|b₃B_{9,7}|b₄B_{9,7}|b₁₃B_{9,7}|b₁₅B_{9,7}|b₁₆B_{9,7},

B_{9,2}→b₁B_{9,6}|b₃B_{9,6}|b₄B_{9,6}|b₁₃B_{9,6}|b₁₅B_{9,6}|b₁₆B_{9,6},

B_{9,3}→b₁B_{9,7}|b₃B_{9,7}|b₅B_{9,7}|b₉B_{9,7}|b₁₁B_{9,7}|b₁₇B_{9,7}|b₂₁B_{9,7}|b₂₂B_{9,7}|b₂₇B_{9,7}|b₂₈B_{9,7},

B_{9,3}→b₁B_{9,6}|b₃B_{9,6}|b₅B_{9,6}|b₉B_{9,6}|b₁₁B_{9,6}|b₁₇B_{9,6}|b₂₁B_{9,6}|b₂₂B_{9,6}|b₂₇B_{9,6}|b₂₈, B_{9,6},

B_{9,4}→b₂B_{9,7}|b₃B_{9,7}|b₄, B_{9,7}|b₆B_{9,7}|b₇B_{9,7}|b₈B_{9,7}|b₁₀B_{9,7}|b₁₁B_{9,7}|b₁₂B_{9,7}|b₁₈B_{9,7}|b₁₉B_{9,7},

B_{9,4}→b₂B_{9,6}|b₃B_{9,6}|b₄B_{9,6}|b₆B_{9,6}|b₇B_{9,6}|b₈B_{9,6}|b₁₀B_{9,6}|b₁₁B_{9,6}|b₁₂B_{9,6}|b₁₈B_{9,6}|b₁₉B_{9,6},

B_{9,5}→b₂B_{9,7}|b₃B_{9,7}|b₆B_{9,7}|b₇B_{9,7}|b₁₀B_{9,7}|b₁₁B_{9,7}|b₁₄B_{9,7}|b₁₅B_{9,7}|b₁₈B_{9,7}|b₁₉B_{9,7},

B_{9,5}→b₂B_{9,6}|b₃B_{9,6}|b₆B_{9,6}|b₇B_{9,6}|b₁₀B_{9,6}|b₁₁B_{9,6}|b₁₄B_{9,6}|b₁₅B_{9,6}|b₁₈B_{9,6}|b₁₉B_{9,6},

B_{9,6}→iB_{9,7}|uB_{9,7}|eB_{9,7}|oB_{9,7},

B_{9,7}→b₃|b₄|b₁₁|b₁₂|b₁₅|b₁₆|b₂₃|b₂₅|b₂₆|b₂₈}

With respect to a Tibetan spelling structure 10:

Tibetan spelling formal grammar G₁₀: the spelling formal grammar G₁₀ of the Tibetan prefixes, the superfixes, the roots, the vowel symbols and the suffixes is a quadruple (T₁₀, V₁₀, S₁₀, P₁₀), wherein:

(1) terminal symbol

T₁₀=T_{B}∪Tₒ, wherein:

T_{B}={b₁, b₃, b₄, b₇, b₉, b₁₁, b₁₂, b₁₅, b₁₆, b₁₇, b₁₉, b₂₃, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₀={S₁₀, B_{10,1}, B_{10,2}, B_{10,3}, B_{10,4}, B_{10,5}, B_{10,6}};

(3) S₁₀ is a non-terminal symbol in V₁₀ and is the start symbol; and

(4) the production set of the grammar G₁₀ is: P₁₀={

B_{10,1}→b₂₈B_{10,2}|b₂₆B_{10,3}|b₂₅B_{10,4},

B_{10,2}→b₁B_{10,6}|b₃B_{10,6}|b₄B_{10,6}|b₈B_{10,6}|b₉B_{10,6}|b₁₁B_{10,6}|b₁₂B_{10,6}|b₁₇B_{10,6},

B_{10,2}→b₁B_{10,5}|b₃B_{10,5}|b₄B_{10,5}|b₈B_{10,5}|b₉B_{10,5}|b₁₁B_{10,5}|b₁₂B_{10,5}|b₁₇B_{10,5},

B_{10,3}→b₉B_{10,6}|b₁₁B_{10,6},

B_{10,3}→b₉B_{10,5}|b₁₁B_{10,5},

B_{10,4}→b₁B_{10,6}|b₃B_{10,6}|b₄B_{10,6}|b₇B_{10,6}|b₈B_{10,6}|b₉B_{10,6}|b₁₁B_{10,6}|b₁₂B_{10,6}|b₁₇B_{10,6}|b₁₉B_{10,6},

B_{10,4}→b₁B_{10,5}|b₃B_{10,5}|b₄B_{10,5}|b₇B_{10,5}|b₈B_{10,5}|b₉B_{10,5}|b₁₁B_{10,5}|b₁₂B_{10,5}|b₁₇B_{10,5}|b₁₉B_{10,5},

B_{10,5}→iB_{10,6}|uB_{10,6}|eB_{10,6}|oB_{10,6},

B_{10,6}→b₃|b₄|b₁₁|b₁₂|b₁₅|b₁₆|b₂₃|b₂₅|b₂₆|b₂₈}

With respect to a Tibetan spelling structure 11:

Tibetan spelling formal grammar G₁₁: the spelling formal grammar G₁₁ of the Tibetan prefixes, the roots, the subfixes, the vowel symbols and the suffixes is a quadruple (T₁₁, V₁₁, S₁₁, P₁₁), wherein:

(1) terminal symbol

T₁₁=T_{B}∪Tₒ, wherein:

T_{B=}{b₁, b₂, b₃, b₄, b₁₁, b₁₂, b₁₃, b₁₄, b₁₅, b₁₆, b₂₂, b₂₃, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₁={S₁₁, B_{11,1}, B_{11,2}, B_{11,3}, B_{11,4}, B_{11,5}, B_{11,6}, B_{11,7}, B_{11,8}, B_{11,9}, B_{11,10}, B_{11,11}, B_{11,12}};

(3) S₁₁ is a non-terminal symbol in V₁₁ and is the start symbol; and

(4) the production set of the grammar G₁₁ is: P₁₁={

S₁₁→b₁₁B_{11,1}|b₁₅B_{11,2}|b₁₆B_{11,3}|b₂₃B_{11,4},

B_{11,1}→b₁₆B_{11,5},

B_{11,1}→b₁B_{11,9}|b₃B_{11,9}|b₁₃B_{11,9}|b₁₅B_{11,9},

B_{11,2}→b₁B_{11,6},

B_{11,2}→b₂₂B_{11,7}|b₂₅B_{11,7},

B_{11,2}→b₂₈B_{11,8},

B_{11,2}→b₃B_{11,9},

B_{11,3}→b₂B_{11,9}|b₃B_{11,9},

B_{11,4}→b₂B_{11,9}|b₃B_{11,9}|b₁₄B_{11,9}|b₁₅B_{11,9},

B_{11,4}→b₁₁B_{11,10},

B_{11,5}→b₂₄B₁₂,

B_{11,5}→b₂₄B_{11,11},

B_{11,6}→b₂₄B_{11,12}|b₂₅B_{11,12}|b₂₆B_{11,12},

B_{11,6}→b₂₄B_{11,11}|b₂₅B_{11,11}|b₂₆B_{11,11},

B_{11,7}→b₂₆B_{11,12},

B_{11,7}→b₂₆B_{11,11},

B_{11,8}→b₂₅B_{11,12}|b₂₆B_{11,12},

B_{11,8}→b₂₅B_{11,11}|b₂₆B_{11,11},

B_{11,9}→b₂₄B_{11,12}|b₂₅B_{11,12},

B_{11,9}→b₂₄B_{11,11}|b₂₅, B_{11,11},

B_{11,10}→b₂₅B_{11,12},

B_{11,10}→b₂₅B_{11,11},

B_{11,11}→iB_{11,12}|uB_{11,12}|eB_{11,12}|oB_{11,12},

B_{11,12}→b₃|b₄|b₁₁|b₁₂|b₁₅|b₁₆|b₂₃|b₂₅|b₂₆|b₂₈}

With respect to a Tibetan spelling structure 12:

Tibetan spelling formal grammar G₁₂: the spelling formal grammar G₁₂ of the Tibetan prefixes, the superfixes, the roots, the subfixes, the vowel symbols and the suffixes is a quadruple (T₁₂, V₁₂, S₁₂, P₁₂), wherein:

(1) terminal symbol

T₁₂=T_{B}∪Tₒ, wherein:

T_{B}={b₁, b₃, b₄, b₁₁, b₁₂, b₁₅, b₁₆, b₂₃, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₂={S₁₂, B_{12,1}, B_{12,2}, B_{12,3}, B_{12,4}, B_{12,5}, B_{12,6}, B_{12,7}};

(3) S₁₂ is a non-terminal symbol in V₁₂ and is the start symbol; and

(4) the production set of the grammar G₁₂ is: P₁₂={

S₁₂→b₁₅B_{12,1},

B_{12,1}→b₂₈B_{12,2},

B_{12,1}→b₂₅B_{12,3},

B_{12,2}→b₁B_{12,4}|b₃B_{12,4},

B_{12,3}→b₁B_{12,5}|b₃B_{12,5},

B_{12,4}→b₂₄B_{12,7}|b₂₅B_{12,7},

B_{12,4}→b₂₄B_{12,6}|b₂₅B_{12,6},

B_{12,5}→b₂₄B_{12,7},

B_{12,5}→b₂₄B_{12,6},

B_{12,6}→iB_{12,7}|uB_{12,7}|eB_{12,7}|oB_{12,7},

B_{12,7}→b₃|b₄|b₁₁|b₁₂|b₁₅|b₁₆|b₂₃|b₂₅|b₂₆|b₂₈}

With respect to a Tibetan spelling structure 13:

Tibetan spelling formal grammar G₁₃: the spelling formal grammar G₁₃ of the Tibetan prefixes, the roots, the vowel symbols, the suffixes and the postfixes is a quadruple (T₁₃, V₁₃, S₁₃, P₁₃), wherein:

(1) terminal symbol

T₁₃=T_{B}∪Tₒ, wherein:

T_{B}={b₁, b₂, b₃, b₄, b₅, b₆, b₇, b₈, b₉, b₁₀, b₁₁, b₁₂, b₁₃, b₁₄, b₁₅, b₁₆, b₁₇, b₁₈, b₁₉, b₂₁, b₂₂, b₂₃, b₂₄, b₂₅, b₂₆, b₂₇, b₂₈}, the elements thereof correspond to the Tibetan consonant characters; and Tₒ={i, u, e, o}, the elements thereof correspond to the Tibetan vowel characters;

(2) non-terminal symbol set

V₁₃={S₁₃, B_{13,1}, B_{13,2}, B_{13,3}, B_{13,4}, B_{13,5}, B_{13,6}, B_{13,7}, B_{13,8}, B_{13,9}};

(3) S₁₃ is a non-terminal symbol in V₁₃ and is the start symbol; and

(4) the production set of the grammar G₁₃ is: P₁₃={

S₁₃→b₃B_{13,1}|b₁₁B_{13,2}|b₁₅B_{13,3}|b₁₆B_{13,4}|b₂₃B_{13,5},

B_{13,1}→b₅B_{13,6}|b₈B_{13,6}|b₉B_{13,6}|b₁₁B_{13,6}|b₁₂B_{13,6}|b₁₇B_{13,6}|b₂₁B_{13,6}|b₂₂B_{13,6}|b₂₄B_{13,6}|b₂₇B_{13,6}|b₂₈B_{13,6},

B_{13,2}→b₁B_{13,6}|b₃B_{13,6}|b₄B_{13,6}|b₁₃B_{13,6}|b₁₅B_{13,6}|b₁₆B_{13,6},

B_{13,3}→b₁B_{13,6}|b₃B_{13,6}|b₅B_{13,6}|b₉B_{13,6}|b₁₁B_{13,6}|b₁₇B_{13,6}|b₂₁B_{13,6}|b₂₂B_{13,6}|b₂₇B_{13,6}|b₂₈B_{13,6},

B_{13,4}→b₂B_{13,6}|b₃B_{13,6}|b₄B_{13,6}|b₆B_{13,6}|b₇B_{13,6}|b₈B_{13,6}|b₁₀B_{13,6}|b₁₁B_{13,6}|b₁₂B_{13,6}|b₁₈B_{13,6}|b₁₉B_{13,6},

B_{13,5}→b₂B_{13,6}|b₃B_{13,6}|b₆B_{13,6}|b₇B_{13,6}|b₁₀B_{13,6}|b₁₁B_{13,6}|b₁₄B_{13,6}|b₁₅B_{13,6}|b₁₈B_{13,6}|b₁₉B_{13,6},

B_{13,6}→iB_{13,7}|uB_{13,7}|eB_{13,7}|oB_{13,7},

B_{13,6}→b₃B_{13,8}|b₄B_{13,8}|b₁₅B_{13,8}|b₁₆B_{13,8},

B_{13,6}→b₁₂B_{13,9}|b₂₅B_{13,9}|b₂₆B_{13,9},

B_{13,7}→b₃B_{13,8}|b₄B_{13,8}|b₁₅B_{13,8}|b₁₆B_{13,8},

B_{13,7}→b₁₂B_{13,9}|b₂₅B_{13,9}|b₂₆B_{13,9},

B_{13,8}→b₂₈,

B_{13,9}→b₁₁}

With respect to a Tibetan spelling structure 14:

Tibetan spelling formal grammar G₁₄: the spelling formal grammar G₁₄ of the Tibetan prefixes, the superfixes, the roots, the vowel symbols, the suffixes and the postfixes is a quadruple (T₁₄, V₁₄, S₁₄, P₁₄), wherein:

(1) terminal symbol

T₁₄=T_{B}∪Tₒ, wherein:

T_{B}={b₁, b₃, b₄, b₁₁, b₁₂, b₁₃, b₁₅, b₁₆, b₁₇, b₂₀, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₄={S₁₄, B_{14,1}, B_{14,2}, B_{14,3}, B_{14,4}, B_{14,5}, B_{14,6}, B_{14,7}, B_{14,8}};

(3) S₁₄ is a non-terminal symbol in V₁₄ and is the start symbol; and

(4) the production set of the grammar G₁₄ is: P₁₄={

S₁₄→b₁₅B_{14,1},

B_{14,1}→b₂₈B_{14,2}|b₂₆B_{14,3}|b₂₅B_{14,4},

B_{14,2}→b₁B_{14,5}|b₃B_{14,5}|b₄B_{14,5}|b₈B_{14,5}|b₉B_{14,5}|b₁₁B_{14,5}|b₁₂B_{14,5}|b₁₇B_{14,5},

B_{14,3}→b₉B_{14,5}|b₁₁B_{14,5},

B_{14,4}→b₁B_{14,5}|b₃B_{14,5}|b₄B_{14,5}|b₇B_{14,5}|b₈B_{14,5}|b₉B_{14,5}|b₁₁B_{14,5}|b₁₂B_{14,5}|b₁₇B_{14,5}|b₁₉B_{14,5},

B_{14,5}→iB_{14,6}|uB_{14,6}|eB_{14,6}|oB_{14,6},

B_{14,5}→b₃B_{14,7}|b₄B_{14,7}|b₁₅B_{14,7}|b₁₆B_{14,7},

B_{14,5}→b₁₂B_{14,8}|b₂₅B_{14,8}|b₂₆B_{14,8},

B_{14,6}→b₃B_{14,7}|b₄B_{14,7}|b₁₅B_{14,7}|b₁₆B_{14,7},

B_{14,6}→b₁₂B_{14,8}|b₂₅B_{14,8}|b₂₆B_{14,8},

B_{14,7}→b₂₈,

B_{14,8}→b₁₁}

With respect to a Tibetan spelling structure 15:

Tibetan spelling formal grammar G₁₅: the spelling formal grammar G₁₅ of the Tibetan prefixes, the roots, the subfixes, the vowel symbols, the suffixes and the postfixes is a quadruple (T₁₅, V₁₅, S₁₅, P₁₅), wherein:

(1) terminal symbol

T₁₅=T_{B}∪Tₒ, wherein:

T_{B}{b₁, b₂, b₃, b₄, b₁₁, b₁₂, b₁₃, b₁₄, b₁₅, b₁₆, b₂₂, b₂₃, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₅={S₁₅, B_{15,1}, B_{15,2}, B_{15,3}, B_{15,4}, B_{15,5}, B_{15,6}, B_{15,7}, B_{15,8}, B_{15,9}, B_{15,10}, B_{15,11}, B_{15,12}, B_{15,13}, B_{15,14}};

(3) S₁₅ is a non-terminal symbol in V₁₅ and is the start symbol; and

(4) the production set of the grammar G₁₅ is: P₁₅={

S₁₅→b₁₁B_{15,1}|b₁₅B_{15,2}|b₁₆B_{15,3}|b₂₃B_{15,4},

B_{15,1}→b₁₆B_{15,5},

B_{15,1}→b₁B_{15,9}|b₃B_{15,9}|b₁₃B_{15,9}|b₁₅B_{15,9},

B_{15,2}→b₁B_{15,6},

B_{15,2}→b₂₂B_{15,7}|b₂₅B_{15,7},

B_{15,2}→b₂₈B_{15,8},

B_{15,2}→b₃B_{15,9},

B_{15,3}→b₂B_{15,9}|b₃B_{15,9},

B_{15,4}→b₂B_{15,9}|b₃B_{15,9}|b₁₄B_{15,9}|b₁₅B_{15,9},

B_{15,4}→b₁₁B_{15,10},

B_{15,5}→b₂₄B_{15,11},

B_{15,6}→b₂₄B_{15,11}|b₂₅B_{15,11}|b₂₆B_{15,11},

B_{15,7}→b₂₆B_{15,11},

B_{15,8}→b₂₅B_{15,11}|b₂₆B_{15,11},

B_{15,9}→b₂₄B_{15,11}|b₂₅B_{15,11},

B_{15,10}→b₂₅B_{15,11},

B_{15,11}→iB_{15,12}|uB_{15,12}|eB_{15,12}|oB_{15,12},

B_{15,11}→b₃B_{15,13}|b₄B_{15,13}|b₁₅B_{15,13}|b₁₆B_{15,13},

B_{15,11}→b₁₂B_{15,4}|b₂₅B_{15,14}|b₂₆B_{15,14},

B_{15,12}→b₃B_{15,13}|b₄B_{15,13}|b₁₅B_{15,13}|b₁₆B_{15,13},

B_{15,12}→b₁₂B_{15,14}|b₂₅B_{15,14}|b₂₆B_{15,14},

B_{15,13}→b₂₈,

B_{15,14}→b₁₁}

With respect to a Tibetan spelling structure 16:

Tibetan spelling formal grammar G₁₆; the Tibetan character spelling grammar G₁₆ of the Tibetan prefixes, the superfixes, the roots, the subfixes, the vowel symbols, the suffixes and the postfixes is a quadruple (T₁₆, V₁₆, S₁₆, P₁₆), wherein:

(1) terminal symbol

T₁₆=T_{B}∪Tₒ, wherein:

T_{B}{b₁, b₃, b₄, b₁₁, b₁₂, b₁₅, b₁₆, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₁₆={S₁₆, B_{16,1}, B_{16,2}, B_{16,3}, B_{16,4}, B_{16,5}, B_{16,6}, B_{16,7}, B_{16,8}, B_{16,9}};

(3) S₁₆ is a non-terminal symbol in V₁₆ and is the start symbol; and

(4) the production set of the grammar G₁₆ is: P₁₆={

S₁₆→b₁₅B_{16,1},

B_{16,1}→b₂₈B_{16,2},

B_{16,1}→b₂₅B_{16,3},

B_{16,2}→b₁B_{16,4}|b₃B_{16,4},

B_{16,3}→b₁B_{16,5}|b₃B_{16,5},

B_{16,4}→b₂₄B_{16,6}|b₂₅B_{16,6},

B_{16,5}→b₂₄B_{16,6},

B_{16,6}→iB_{16,7}|uB_{16,7}|eB_{16,7}|oB_{16,7},

B_{16,6}→b₃B_{16,8}|b₄B_{16,8}|b₁₅B_{16,8}|b₁₆B_{16,8},

B_{16,6}→b₁₂B_{16,9}|b₂₅B_{16,9}|b₂₆B_{16,9},

B_{16,7}→b₃B_{16,8}|b₄B_{16,8}|b₁₅B_{16,8}|b₁₆B_{16,8},

B_{16,7}→b₁₂B_{16,9}|b₂₅B_{16,9}|b₂₆B_{16,9},

B_{16,8}→b₂₈,

B_{16,9}→b₁₁}

With respect to a Tibetan spelling structure 17:

Tibetan spelling formal grammar G₁₇: the spelling formal grammar G₁₇ of the Tibetan roots, the vowel symbols and the suffixes is a quadruple (T₁₇, V₁₇, S₁₇, P₁₇), wherein:

(1) terminal symbol

T₁₇=T_{B}∪Tₒ, wherein:

T_{B}={b₁, b₂, b₃, b₄, b₅, . . . , b₃₀}, the elements thereof correspond to the Tibetan consonant characters; and Tₒ={i, u, e, o}, the elements thereof correspond to the Tibetan vowel characters;

(2) non-terminal symbol set

V₁₇={S₁₇, B_{17,1}, B_{17,2}};

(3) S₁₇ is a non-terminal symbol in V₁₇ and is the start symbol; and

(4) the production set of the grammar G₁₇ is: P₁₇={

S₁₇→b₁B_{17,1}|b₂B_{17,1}|b₃B_{17,1}|b₄B_{17,1}|b₅B_{17,1}| . . . |b₃₀B_{17,1},

S₁₇→b₁B_{17,2}|b₂B_{17,2}|b₃B_{17,2}|b₄B_{17,2}|b₅B_{17,2}| . . . |b₃₀B_{17,2},

B_{17,1}→|iB_{17,2}|uB_{17,2}|eB_{17,2}|oB_{17,2},

B_{17,2}→b₃|b₄|b₁₁|b₁₂|b₁₅|b₁₆|b₂₃|b₂₅|b₂₆|b₂₈}

With respect to a Tibetan spelling structure 18:

Tibetan spelling formal grammar G₁₈: the spelling formal grammar G₁₈ of the Tibetan superfixes, the roots, the vowel symbols and the suffixes is a quadruple (T₁₈, V₁₈, S₁₈, P₁₈), wherein:

(1) terminal symbol

T₁₈=T_{B}∪Tₒ, wherein:

T_{B}={b₁, b₃, b₄, b₅, b₇, b₈, b₉, b₁₁, b₁₂, b₁₃, b₁₅, b₁₆, b₁₇, b₁₉, b₂₃, b₂₅, b₂₆, b₂₈, b₂₉}, the elements thereof correspond to the Tibetan consonant characters; and Tₒ={i, u, e, o}, the elements thereof correspond to the Tibetan vowel characters;

(2) non-terminal symbol set

V₁₈={S₁₈, B_{18,1}, B_{18,2}, B_{18,3}, B_{18,4}, B_{18,5}};

(3) S₁₈ is a non-terminal symbol in V₁₈ and is the start symbol; and

(4) the production set of the grammar G₁₈ is: P₁₈={

S₁₈→b₂₅B_{18,1}|b₂₆B_{18,2}|b₂₈B_{18,3},

B_{18,1}→b₁B_{18,5}|b₃B_{18,5}|b₄B_{18,5}|b₇B_{18,5}|b₈B_{18,5}|b₉B_{18,5}|b₁₁B_{18,5}|b₁₂B_{18,5}|b₁₅B_{18,5}|b₁₆B_{18,5}|b₁₇B_{18,5}|b₁₉B_{18,5},

B_{18,1}→b₁B_{18,4}|b₃B_{18,4}|b₄B_{18,4}|b₇B_{18,4}|b₈B_{18,4}|b₉B_{18,4}|b₁₁, B_{18,4}|b₁₂B_{18,4}|b₁₅B_{18,4}|b₁₆B_{18,4}|b₁₇B_{18,4}|b₁₉B_{18,4},

B_{18,2}→b₁B_{18,5}|b₃B_{18,5}|b₄B_{18,5}|b₅B_{18,5}|b₇B_{18,5}|b₉B_{18,5}|b₁₁B_{18,5}|b₁₃B_{18,5}|b₁₅B_{18,5}|b₂₉B_{18,5},

B_{18,2}→b₁B_{18,4}|b₃B_{18,4}|b₄B_{18,4}|b₅B_{18,4}|b₇B_{18,4}|b₉B_{18,4}|b₁₁B_{18,4}|b₁₃B_{18,4}|b₁₅B_{18,4}|b₂₉B_{18,4},

B_{18,3}→b₁B_{18,5}|b₃B_{18,5}|b₄, B_{18,5}|b₈B_{18,5}|b₉B_{18,5}|b₁₁B_{18,5}|b₁₂B_{18,5}|b₁₃B_{18,5}|b₁₅B_{18,5}|b₁₆B_{18,5}|b₁₇B_{18,5},

B_{18,3}→b₁B_{18,4}|b₃B_{18,4}|b₄B_{18,4}|b₈B_{18,4}|b₉B_{18,4}|b₁₁B_{18,4}|b₁₂B_{18,4}|b₁₃B_{18,4}|b₁₅B_{18,4}|b₁₆B_{18,4}|b₁₇B_{18,4},

B_{18,4}→iB_{18,5}|uB_{18,5}|eB_{18,5}|oB_{18,5},

B_{18,5}→b₃|b₄|b₁₁|b₁₂|b₁₅|b₁₆|b₂₃|b₂₅|b₂₆|b₂₈}

With respect to a Tibetan spelling structure 19:

Tibetan spelling formal grammar G₁₉: the spelling formal grammar G₁₉ of the Tibetan roots, the subfixes, the vowel symbols and the suffixes is a quadruple (T₆, V₆, S₆, P₆), wherein:

(1) terminal symbol

T₁₉=T_{B}∪Tₒ, wherein:

T_{B}={b₁, b₂, b₃, b₄, b₈, b₉, b₁₀, b₁₁, b₁₂, b₁₃, b₁₄, b₁₅, b₁₆, b₁₈, b₂₀, b₂₁, b₂₂, b₂₃, b₂₄, b₂₅, b₂₆, b₂₇, b₂₈, b₂₉}, the elements thereof correspond to the Tibetan consonant characters; and Tₒ={i, u, e, o}, the elements thereof correspond to the Tibetan vowel characters;

(2) non-terminal symbol set

V₁₉={S₁₉, B_{19,1}, B_{19,2}, B_{19,3}, B_{19,4}, B_{19,5}, B_{19,6}, B_{19,7}, B_{19,8}, B_{19,9}, B_{19,10}, B_{19,11}};

(3) S₁₉ is a non-terminal symbol in V₁₉ and is the start symbol; and

(4) the production set of the grammar G₁₉ is: P₁₉={

S₁₉→b₁B_{19,1}|b₃B_{19,1},

S₁₉→b₂B_{19,2},

S₁₉→b₁₁B_{19,3}|b₂₉B_{19,3},

S₁₉→b₈B_{19,4}|b₁₈B_{19,4}|b₂₁B_{19,4}|b₂₆B_{19,4}|b₂₇B_{19,4},

S₁₉→b₉B_{19,5}|b₁₀B_{19,5},

S₁₉→b₁₃B_{19,6}|b₁₄B_{19,6}|b₁₆B_{19,6},

S₁₉→b₂₂B_{19,7}|b₂₅B_{19,7},

S₁₉→b₂₈B_{19,8},

S₁₉→b₁₅B_{19,9},

B_{19,1}→b₂₀B_{19,11}|b₂₄B_{19,11}|b₂₅B_{19,11}|b₂₆B_{19,11},

B_{19,1}→b₂₀B_{19,10}|b₂₄B_{19,10}|b₂₅B_{19,10}|b₂₆B_{19,10},

B_{19,2}→b₂₀B_{19,11}|b₂₄B_{19,11}|b₂₅B_{19,11},

B_{19,2}→b₂₀B_{19,10}|b₂₄B_{19,10}|b₂₅B_{19,10},

B_{19,3}→b₂₀B_{19,11}|b₂₅B_{19,11},

B_{19,3}→b₂₀B_{19,10}|b₂₅B_{19,10},

B_{19,4}→b₂₀B_{19,11},

B_{19,4}→b₂₀B_{19,10},

B_{19,5}→b₂₅B_{19,11},

B_{19,5}→b₂₅B_{19,10},

B_{19,6}→b₂₄B_{19,11}|b₂₅B_{19,11},

B_{19,6}→b₂₄B_{19,10}|b₂₅B_{19,10},

B_{19,7}→b₂₀B_{19,11}|b₂₆B_{19,11},

B_{19,7}→b₂₀B_{19,10}|b₂₆B_{19,10},

B_{19,8}→b₂₅B_{19,11}|b₂₆B_{19,11},

B_{19,8}→b₂₅B_{19,10}|b₂₆B_{19,10},

B_{19,9}→b₂₄B_{19,11}|b₂₅B_{19,11}|b₂₆B_{19,11},

B_{19,9}→b₂₄B_{19,10}|b₂₅B_{19,10}|b₂₆B_{19,10},

B_{19,10}→iB_{19,11}|uB_{19,11}|eB_{19,11}|oB₁₉ₘ,

B_{19,11}→b₃|b₄|b₁₁|b₁₂|b₁₅|b₁₆|b₂₃|b₂₅|b₂₆|b₂₈}

With respect to a Tibetan spelling structure 20:

Tibetan spelling formal grammar G₂₀: the spelling formal grammar G₂₀ of the superfixes, the Tibetan roots, the subfixes, the vowel symbols and the suffixes is a quadruple (T₂₀, V₂₀, S₂₀, P₂₀), wherein:

(1) terminal symbol

T₂₀=T_{B}∪Tₒ, wherein:

T_{B}={b₁, b₃, b₄, b₁₁, b₁₂, b₁₃, b₁₅, b₁₆, b₁₇, b₂₀, b₂₃, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₂₀={S₂₀, B_{20,1}, B_{20,2}, B_{20,3}, B_{20,4}, B_{20,5}, B_{20,6}, B_{20,7}, B_{20,8}};

(3) S₂₀ is a non-terminal symbol in V₂₀ and is the start symbol; and

(4) the production set of the grammar G₂₀ is: P₂₀={

S₂₀→b₂₅B_{20,1},

S₂₀→b₂₈B_{20,2},

B_{20,1}→b₁B_{20,3}|b₃B_{20,3}|b₁₆B_{20,3},

B_{20,1}→b₁₇B_{20,4},

B_{20,2}→b₁B_{20,5}|b₃B_{20,5}|b₁₃B_{20,5}|b₁₅B_{20,5}|b₁₆B_{20,5},

B_{20,2}→b₁₂B_{20,6},

B_{20,3}→b₂₄B_{20,8},

B_{20,3}→b₂₄B_{20,7},

B_{20,4}→b₂₀B_{20,8},

B_{20,4}→b₂₀B_{20,7},

B_{20,5}→b₂₄B_{20,8}|b₂₅B_{20,8},

B_{20,5}→b₂₄B_{20,7}|b₂₅B_{20,7},

B_{20,6}→b₂₅B_{20,8},

B_{20,6}→b₂₅B_{20,7},

B_{20,7}→iB_{20,8}|uB_{20,8}|eB_{20,8}|oB_{20,8},

B_{20,8}→b₃|b₄|b₁₁|b₁₂|b₁₅|b₁₆|b₂₃|b₂₅|b₂₆|b₂₈}

With respect to a Tibetan spelling structure 21:

Tibetan spelling formal grammar G₂₁: the spelling formal grammar G₂₁ of the Tibetan roots, the vowel symbols, the suffixes and the postfixes is a quadruple (T₂₁, V₂₁, S₂₁, P₂₁), wherein:

(1) terminal symbol

T₂₁=T_{B}∪Tₒ, wherein:

T_{B}={b₁, b₂, b₃, b₄, b₅, . . . , b₃₀}, the elements thereof correspond to the Tibetan consonant characters; and Tₒ={i, u, e, o}, the elements thereof correspond to the Tibetan vowel characters;

(2) non-terminal symbol set

V₂₁={S₂₁, B_{21,1}, B_{21,2}, B_{21,3}, B_{24,4}, B_{21,5}, B_{21,6}, B_{21,7}};

(3) S₂₁ is a non-terminal symbol in V₂₁ and is the start symbol; and

(4) the production set of the grammar G₂₁ is: P₂₁={

S₂₁→b₁B_{21,1}|b₂B_{21,1}| . . . |b₁₀B_{21,1}|b₁₂B_{21,1}|b₁₃B_{21,1}| . . . |b₂₂B_{21,1}|b₂₄B_{21,1}|b₂₅B_{21,1}| . . . |b₃₀B_{21,1},

S₂₁→b₁₁B_{21,2},

S₂₁→b₂₃B_{21,3},

B_{21,1}→iB_{21,4}|uB_{21,4}|eB_{21,4}|oB_{21,4},

B_{21,1}→b₃B_{21,7}|b₄B_{21,7}|b₁₅B_{21,7}|b₁₆B_{21,7},

B_{21,2}→iB_{21,5}|uB_{21,5}|eB_{21,5}|oB_{21,5},

B_{21,3}→b₄B_{21,7}|b₁₆B_{21,7},

B_{21,3}→iB_{21,6}|uB_{21,6}|eB_{21,6}|oB_{21,6},

B_{21,4}→b₃B_{21,7}|b₄B_{21,7}|b₁₅B_{21,7}|b₁₆B_{21,7},

B_{21,5}→b₃B_{21,7}|b₄B_{21,7}|b₁₅B_{21,7}|b₁₆B_{21,7},

B_{21,6}→b₃B_{21,7}|b₄B_{21,7}|b₁₅B_{21,7}|b₁₆B_{21,7},

B_{21,7}→b₂₈}

With respect to a Tibetan spelling structure 22:

Tibetan spelling formal grammar G₂₂: the spelling formal grammar G₂₂ of the Tibetan superfixes, the roots, the vowel symbols, the suffixes and the postfixes is a quadruple (T₂₂, V₂₂, S₂₂, P₂₂), wherein:

(1) terminal symbol

T₂₂=T_{B}∪Tₒ, wherein:

T_{B}={b₁, b₃, b₄, b₅, b₇, b₈, b₉, b₁₁, b₁₂, b₁₃, b₁₅, b₁₆, b₁₇, b₁₉, b₂₅, b₂₆, b₂₈, b₂₉}, the elements thereof correspond to the Tibetan consonant characters; and Tₒ={i, u, e, o}, the elements thereof correspond to the Tibetan vowel characters;

(2) non-terminal symbol set

V₂₂={S₂₂, B_{22,1}, B_{22,2}, B_{22,3}, B_{22,4}, B_{22,5}};

(3) S₂₂ is a non-terminal symbol in V₂₂ and is the start symbol; and

(4) the production set of the grammar G₂₂ is: P₂₂={

S₂₂→b₂₅B_{22,1}|b₂₆B_{22,2}|b₂₈B_{22,3},

B_{22,1}→b₁B_{22,4}|b₃B_{22,4}|b₄B_{22,4}|b₇B_{22,4}|b₈B_{22,4}|b₉B_{22,4}|b₁₁B_{22,4}|b₁₂B_{22,4}|b₁₅B_{22,4}|b₁₆B_{22,4}|b₁₇B_{22,4}|b₁₉B_{22,4},

B_{22,2}→b₁B_{22,4}|b₃B_{22,4}|b₄B_{22,4}|b₅B_{22,4}|b₇B_{22,4}|b₉B_{22,4}|b₁₁B_{22,4}|b₁₃B_{22,4}|b₁₅B_{22,4}|b₂₉B_{22,4},

B_{22,3}→b₁B_{22,4}|b₃B_{22,4}|b₄B_{22,4}|b₈B_{22,4}|b₉B_{22,4}|b₁₁B_{22,4}|b₁₂B_{22,4}|b₁₃B_{22,4}|b₁₅B_{22,4}|b₁₆B_{22,4}|b₁₇B_{22,4},

B_{22,4}→B_{22,7}|uB_{22,7}|eB_{22,7}|oB_{22,7},

B_{22,4}→b₁₂B_{22,5}|b₂₅B_{22,5}|b₂₆B_{22,5},

B_{22,4}→b₃B_{22,6}|b₄B_{22,6}|b₁₅B_{22,6}|b₁₆B_{22,6},

B_{22,7}→b₁₂B_{22,5}|b₂₅B_{22,5}|b₂₆B_{22,5},

B_{22,7}→b₃B_{22,6}|b₄B_{22,6}|b₁₅B_{22,6}|b₁₆B_{22,6},

B_{2,25}→b₁₁,

B_{2,26}→b₁₈}

With respect to a Tibetan spelling structure 23:

Tibetan spelling formal grammar G₂₃: the Tibetan character spelling grammar G₂₃ of the Tibetan roots, the subfixes, the vowel symbols, the suffixes and the postfixes is a quadruple (T₂₃, V₂₃, S₂₃, P₂₃), wherein:

(1) terminal symbol

T₂₃=T_{B}∪Tₒ, wherein:

T_{B}{b₁, b₂, b₃, b₄, b₈, b₉, b₁₀, b₁₁, b₁₂, b₁₃, b₁₄, b₁₅, b₁₆, b₁₈, b₂₀, b₂₁, b₂₂, b₂₄, b₂₅, b₂₆, b₂₇, b₂₈, b₂₉}, the elements thereof correspond to the Tibetan consonant characters; and Tₒ={i, u, e, o}, the elements thereof correspond to the Tibetan vowel characters;

(2) non-terminal symbol set

V₂₃{S₂₃, B_{23,1}, B_{23,2}, B_{23,3}, B_{23,4}, B_{23,5}, B_{23,6}, B_{23,7}, B_{23,8}, B_{23,9}, B_{23,10}, B_{23,11}, B_{23,12}, B_{23,13}};

(3) S₂₃ is a non-terminal symbol in V₂₃ and is the start symbol; and

(4) the production set of the grammar G₂₃ is: P₂₃={

S₂₃→b₁B_{23,1}|b₃B_{23,1},

S₂₃→b₂B_{23,2},

S₂₃→b₁₁B_{23,3}|b₂₉B_{23,3},

S₂₃→b₈B_{23,4}|b₁₈B_{23,4}|b₂₁B_{23,4}|b₂₆B_{23,4}|b₂₇B_{23,4},

S₂₃→b₉B_{23,5}|b₁₀B_{23,5},

S₂₃→b₁₃B_{23,6}|b₁₄B_{23,6}|b₁₆B_{23,6},

S₂₃→b₂₂B_{23,7}|b₂₅B_{23,7},

S₂₃→b₂₈B_{23,8},

S₂₃→b₁₅B_{23,9},

B_{23,1}→b₂₀B_{23,10}|b₂₄|B_{23,10}|b₂₅B_{23,10}|b₂₆B_{23,10},

B_{23,2}→b₂₀B_{23,10}|b₂₄B_{23,10}|b₂₅B_{23,10},

B_{23,3}→b₂₀B_{23,10}|b₂₅B_{23,10},

B_{23,4}→b₂₀B_{23,10},

B_{23,5}→b₂₅B_{23,10},

B_{23,6}→b₂₄B_{23,10}|b₂₅B_{23,10},

B_{23,7}→b₂₀B_{23,10}|b₂₆B_{23,10},

B_{23,8}→b₂₅B_{23,10}|b₂₆B_{23,10},

B_{23,9}→b₂₄B_{23,10}|b₂₅B_{23,10}|b₂₆B_{23,10},

B_{23,10}→iB_{23,11}|uB_{23,11}|eB_{23,11}|oB_{23,11},

B_{23,10}→b₁₂B_{23,12}|b₂₅B_{23,12}|b₂₆B_{23,12},

B_{23,10}→b₃B_{23,13}|b₄B_{23,13}|b₁₅B_{23,13}|b₁₆B_{23,13},

B_{23,11}→b₁₂B_{23,12}|b₂₅B_{23,12}|b₂₆B_{23,12},

B_{23,11}→b₃B_{23,13}|b₄B_{23,13}|b₁₅B_{23,13}|b₁₆B_{23,13},

B_{23,12}→b₁₁,

B_{23,13}|b₁₈}

With respect to a Tibetan spelling structure 24:

Tibetan spelling formal grammar G₂₄: the spelling formal grammar G₂₄ of the Tibetan superfixes, the roots, the subfixes, the vowel symbols, the suffixes and the postfixes is a quadruple (T₂₄, V₂₄, S₂₄, P₂₄), wherein:

(1) terminal symbol

T₂₄=T_{B}∪Tₒ, wherein:

T_{B}={b₁, b₃, b₄, b₁₁, b₁₂, b₁₃, b₁₅, b₁₆, b₁₇, b₂₀, b₂₄, b₂₅, b₂₆, b₂₈}, the elements thereof correspond to the Tibetan consonant characters; and Tₒ={i, u, e, o}, the elements thereof correspond to the Tibetan vowel characters;

(2) non-terminal symbol set

V₂₄={S₂₄, B_{24,1}, B_{24,2}, B_{24,3}, B_{24,4}, B_{24,5}, B_{24,6}, B_{24,7}, B_{24,8}, B_{24,9}, B_{24,10}};

(3) S₂₄ is a non-terminal symbol in V₂₄ and is the start symbol; and

(4) the production set of the grammar G₂₄ is: P₂₄={

S₂₄→b₂₅B_{24,1},

S₂₄→b₂₈B_{24,2},

B_{24,1}→b₁B_{24,3}|b₃B_{24,3}|b₁₆B_{24,3},

B_{24,1}→b₁₇B_{24,4},

B_{24,2}→b₁B_{24,5}|b₃B_{24,5}|b₁₃B_{24,5}|b₁₅B_{24,5}|b₁₆B_{24,5},

B_{24,2}→b₁₂B_{24,6},

B_{24,3}→b₂₄B_{24,7},

B_{24,4}→b₂₀B_{24,7},

B_{24,5}→b₂₄B_{24,7}|b₂₅B_{24,7},

B_{24,6}→b₂₅B_{24,7},

B_{24,7}→iB_{24,8}|uB_{24,8}|eB_{24,8}|oB_{24,8},

B_{24,7}→b₁₂B_{24,9}|b₂₅B_{24,9}|b₂₆B_{24,9},

B_{24,7}→b₃B_{24,10}|b₄B_{24,10}|b₁₅B_{24,10}|b₁₆B_{24,10},

B_{24,8}→b₁₂B_{24,9}|b₂₅B_{24,9}|b₂₆B_{24,9},

B_{24,8}→b₃B_{24,10}|b₄B_{24,10}|b₁₅B_{24,10}|b₁₆B_{24,10},

B_{24,9}→b₁₁,

B_{24,10}→b₁₈}

In the embodiment, the process of acquiring a newly added non-terminal symbol Eᵢ includes: judging whether the finite set Pᵢ of the production rules of the Tibetan spelling formal grammar Gᵢ contains a production rule B→x, wherein BεVᵢ and xεTᵢ; and if so, acquiring Eᵢεδᵢ (B, x), wherein δᵢ (B, x)=φ. Eᵢ belongs to one of the non-terminal symbols.

Step 103, the constituents of the Tibetan characters are acquired according to a target finite state automaton, when the target finite state automaton in the finite state automaton group determines that the Tibetan characters in the Tibetan text are correctly spelled.

In the embodiment, the process of determining the target finite state automaton through the step 103 can include: each finite state automaton in the finite state automaton group sequentially receives at least one Tibetan character from the initial state and transfers the state; if a certain finite state automaton in the finite state automaton group can enter the termination state after transferring the state, the Tibetan text to be checked is correctly spelled; if none of the finite state automata in the finite state automaton group can enter the termination state after transferring the state, the Tibetan text to be checked is wrongly spelled. The finite state automaton which determines that the Tibetan text to be checked is correctly spelled is the target finite state automaton.

Wherein, the operation of transferring the state can be as follows: the finite state automaton Mᵢ receives a certain input character at a certain state, for example, qₘ (qₘεQᵢ), if x (xεΣᵢ), if the state transition function δₘ (qₘ, x)εδᵢ then the automaton enters the state qₘ₊₁ (qₘ₊₁ε(qₘ, x)), and otherwise, the state of the automaton is not changed.

In the embodiment, the process of acquiring the constituents of the Tibetan characters through the step 103 can include: at first, acquiring a target Tibetan spelling formal grammar corresponding to the target finite state automaton; and then, acquiring the constituents of the Tibetan characters according to the target Tibetan spelling formal grammar.

In the embodiment, the constituents of the Tibetan characters are in one-to-one correspondence with the Tibetan spelling formal grammars. Specifically, the constituents of the Tibetan characters have 24 basic spelling structures as follows:

Basic spelling structure 1 of the Tibetan characters: the Tibetan roots are spelled with the vowel symbols.

Basic spelling structure 2 of the Tibetan characters: the Tibetan superfixes, the roots and the vowels are spelled.

Basic spelling structure 3 of the Tibetan characters: the Tibetan roots, the subfixes and the vowel symbols are spelled.

Basic spelling structure 4 of the Tibetan characters: the superfixes, the Tibetan roots, the subfixes and the vowel symbols are spelled.

Basic spelling structure 5 of the Tibetan characters: the Tibetan prefixes, the superfixes, the roots and the vowel symbols are spelled.

Basic spelling structure 6 of the Tibetan characters: the Tibetan prefixes, the roots, the subfixes and the vowel symbols are spelled.

Basic spelling structure 7 of the Tibetan characters: the Tibetan prefixes, the superfixes, the roots, the subfixes and the vowel symbols are spelled.

Basic spelling structure 8 of the Tibetan characters: the Tibetan prefixes, the roots and the vowel symbols are spelled.

Basic spelling structure 9 of the Tibetan characters: the Tibetan prefixes, the roots, the vowel characters and the suffixes are spelled.

Basic spelling structure 10 of the Tibetan characters: the Tibetan prefixes, the superfixes, the roots, the vowel symbols and the suffixes are spelled.

Basic spelling structure 11 of the Tibetan characters: the Tibetan prefixes, the roots, the subfixes, the vowel symbols and the suffixes are spelled.

Basic spelling structure 12 of the Tibetan characters: the Tibetan prefixes, the superfixes, the roots, the subfixes, the vowel symbols and the suffixes are spelled.

Basic spelling structure 13 of the Tibetan characters: the Tibetan prefixes, the roots, the vowel symbols, the suffixes and the postfixes are spelled.

Basic spelling structure 14 of the Tibetan characters: the Tibetan prefixes, the superfixes, the roots, the vowel symbols, the suffixes and the postfixes are spelled.

Basic spelling structure 15 of the Tibetan characters: the Tibetan prefixes, the roots, the subfixes, the vowel symbols, the suffixes and the postfixes are spelled.

Basic spelling structure 16 of the Tibetan characters: the Tibetan prefixes, the superfixes, the roots, the subfixes, the vowel symbols, the suffixes and the postfixes are spelled.

Basic spelling structure 17 of the Tibetan characters: the Tibetan roots, the vowel symbols and the suffixes are spelled.

Basic spelling structure 18 of the Tibetan characters: the Tibetan superfixes, the roots, the vowel symbols and the suffixes are spelled.

Basic spelling structure 19 of the Tibetan characters: the Tibetan roots, the subfixes, the vowel symbols and the suffixes are spelled.

Basic spelling structure 20 of the Tibetan characters: the superfixes, the Tibetan roots, the subfixes, the vowel symbols and the suffixes are spelled.

Basic spelling structure 21 of the Tibetan characters: the Tibetan roots, the vowel symbols, the suffixes and the postfixes are spelled.

Basic spelling structure 22 of the Tibetan characters: the Tibetan superfixes, the roots, the vowel symbols, the suffixes and the postfixes are spelled.

Basic spelling structure 23 of the Tibetan characters: the Tibetan roots, the subfixes, the vowel symbols, the suffixes and the postfixes are spelled.

Basic spelling structure 24 of the Tibetan characters: the Tibetan superfixes, the roots, the subfixes, the vowel symbols, the suffixes and the postfixes are spelled.

It should be noted that the vowel symbols in the basic spelling structure 8 of the Tibetan characters are essential, and apart from this, the vowel symbols in the other structures are optional.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

### Second Embodiment

As shown in FIG. 2, the embodiment of the present invention provides a Tibetan sorting method, including:

step 201, at least two Tibetan characters to be sorted are acquired.

In the embodiment, the at least two Tibetan characters acquired in the step 201 can be independent Tibetan characters and can also be a Tibetan text composed of a plurality of Tibetan characters, and this is not limited herein. Particularly, when the Tibetan text of at least two Tibetan characters is acquired, the Tibetan text can be segmented at first, the segmentation process is similar to the segmentation mode in the step 101 as shown in FIG. 1, and thus will not be repeated redundantly herein.

Step 202, the at least two Tibetan characters to be sorted are respectively used as the input of a preset finite state automaton group.

Step 203, the constituents of the Tibetan characters are acquired according to a target finite state automaton, when the target finite state automaton in the finite state automaton group determines that the input Tibetan characters are correctly spelled.

In the embodiment, the process of acquiring the constituents of the Tibetan characters in the step 202 and the step 203 is similar to that in the step 102 and the step 103 as shown in FIG. 1, and thus will not be repeated redundantly herein.

Step 204, the at least two Tibetan characters are sorted according to the constituents of the at least two Tibetan characters to acquire a sorting result.

In the embodiment, for any two Tibetan characters in the at least two Tibetan characters, the sorting process in the step 204 includes: 2041, judging whether the two Tibetan characters conform to a preset constituent rule according to the constituents of the two Tibetan characters; if so, executing 2042; otherwise, executing 2044; 2042, judging whether the roots of the two Tibetan characters are the same; if so, executing 2043; otherwise, executing 2044; 2043, sequentially comparing the constituents of the two Tibetan characters according to the sequence of prefixes, superfixes, subfixes, vowels, suffixes and postfixes; executing 2045; 2044, sequentially comparing the constituents of the two Tibetan characters according to the sequence of superfixes, prefixes, subfixes, vowels, suffixes and postfixes; executing 2045; and 2045, if the comparison result is that the former Tibetan character in the two Tibetan characters is larger than the latter Tibetan character, exchanging the sequence of the two Tibetan characters; and otherwise, keeping the sequence of the two Tibetan characters unchanged. Wherein, 2041 includes: acquiring spelling structure serial numbers of the two Tibetan characters according to the constituents of the two Tibetan characters; and judging whether the two Tibetan characters conform to the preset constituent rule according to the spelling structure serial numbers of the two Tibetan characters, wherein the constituent rule includes: the spelling structure serial number of the first Tibetan character in the two Tibetan characters belongs to a set {2, 4, 18, 20, 22, 24}, and the spelling structure serial number of the second Tibetan character in the two Tibetan characters belongs to a set {5, 7, 10, 12, 14, 16}; or, the spelling structure serial number of the first Tibetan character in the two Tibetan characters belongs to the set {5, 7, 10, 12, 14, 16}, and the spelling structure serial number of the second Tibetan character in the two Tibetan characters belongs to the set {2, 4, 18, 20, 22, 24}.

In the embodiment, the constituents of the Tibetan character can be summarized as including the following 7 symbols: the root, the prefix, the superfix, the subfix, the vowel, the suffix and the postfix. When the constituents of the Tibetan character do not contain one or several certain symbols, the corresponding symbol mark of the Tibetan character is 0.

In the embodiment, after the any two Tibetan characters in the at least two Tibetan characters are sorted via the above process, all of the at least two Tibetan characters can be sorted by adopting a bubble algorithm and other sorting methods.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

### Third Embodiment

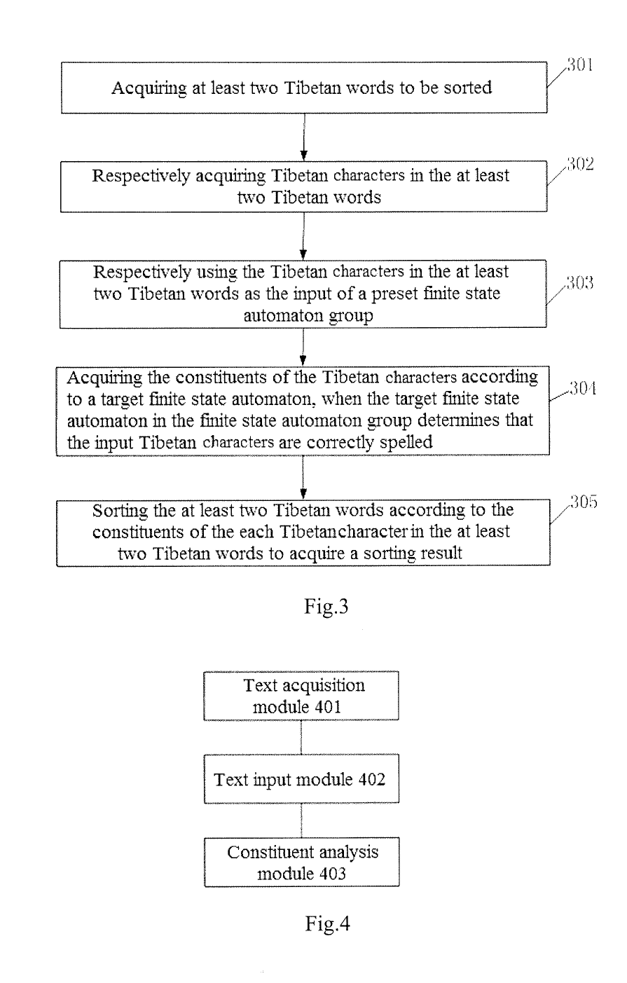

As shown in FIG. 3, the embodiment of the present invention provides a Tibetan sorting method, including:

step 301, at least two Tibetan words to be sorted are acquired.

Step 302, Tibetan characters in the at least two Tibetan words are respectively acquired.

In the embodiment, the at least two Tibetan words can be segmented to acquire the Tibetan characters; and the at least two Tibetan words can be divided according to a specific separator and other signs to acquire the Tibetan characters, which will not be repeated redundantly herein.

S303, the Tibetan characters in the at least two Tibetan words are respectively used as the input of a preset finite state automaton group.

Step 304, the constituents of the Tibetan characters are acquired according to a target finite state automaton, when the target finite state automaton in the finite state automaton group determines that the input Tibetan characters are correctly spelled.

In the embodiment, the process of acquiring the constituents of the Tibetan characters in the step 303 and the step 304 is similar to that in the step 102 and the step 103 as shown in FIG. 1, and thus will not be repeated redundantly herein.

Step 305, the at least two Tibetan words are sorted according to the constituents of the each Tibetan character in the at least two Tibetan words to acquire a sorting result.

In the embodiment, for any two Tibetan words in the at least two Tibetan words, the sorting process in the step 305 includes: 3051, respectively acquiring first Tibetan characters in the two Tibetan words; 3052, judging whether the two Tibetan characters conform to a preset constituent rule according to the constituents of the Tibetan characters; if so, executing 3053; otherwise, executing 3055; 3053, judging whether the roots of the Tibetan characters are the same; if so, executing 3054; otherwise, executing 3055; 3504, sequentially comparing the constituents of the Tibetan characters according to the sequence of prefixes, superfixes, subfixes, vowels, suffixes and postfixes; executing 3056; 3055, sequentially comparing the constituents of the Tibetan characters according to the sequence of superfixes, prefixes, subfixes, vowels, suffixes and postfixes; executing 3056; and 3056, if the comparison result is that the Tibetan characters in the former Tibetan word are larger than the corresponding Tibetan characters in the latter Tibetan word, exchanging the sequence of the two Tibetan words; if the comparison result is that the Tibetan characters in the former Tibetan word are smaller than the corresponding Tibetan characters in the latter Tibetan word, keeping the sequence of the two Tibetan words unchanged; and if the comparison result is that the Tibetan characters in the former Tibetan word are equal to the corresponding Tibetan characters in the latter Tibetan word, acquiring the next Tibetan characters in the at least two Tibetan words, and executing 3052 to 3056 until all the Tibetan characters in the two Tibetan words are completely compared. Wherein, the process of judging whether the judging whether the two Tibetan characters conform to the constituent rule in 3052 is similar to that provided in the second embodiment, and thus will not be repeated redundantly herein.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

### Fourth Embodiment

As shown in FIG. 4, the embodiment of the present invention provides a Tibetan character constituent analysis device, including:

a text acquisition module 401, used for acquiring a Tibetan text to be analyzed;

a text input module 402, connected with the text acquisition module and used for using Tibetan characters in the Tibetan text as the input of a preset finite state automaton group; and

a constituent analysis module 403, connected with the text input module and used for acquiring the constituents of the Tibetan characters according to a target finite state automaton, when the target finite state automaton in the finite state automaton group determines that the Tibetan characters in the Tibetan text are correctly spelled;

the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

In the embodiment, the process of implementing Tibetan character constituent analysis through the text acquisition module 401, the text input module 402 and the constituent analysis module 403 is similar to the process provided by the first embodiment of the present invention, and thus will not be repeated redundantly herein.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

### Fifth Embodiment

As shown in FIG. 5, the embodiment of the present invention provides a Tibetan sorting device, including:

a Tibetan character acquisition module 501, used for acquiring at least two Tibetan characters to be sorted;

a Tibetan character input module 502, connected with the Tibetan character acquisition module and used for respectively using the at least two Tibetan characters to be sorted as the input of a preset finite state automaton group;

a constituent analysis module 503, connected with the Tibetan character input module and used for acquiring the constituents of the Tibetan characters according to a target finite state automaton, when the target finite state automaton in the finite state automaton group determines that the input Tibetan characters are correctly spelled; and

a sorting module 504, connected with the constituent analysis module and used for sorting the at least two Tibetan characters according to the constituents of the at least two Tibetan characters to acquire a sorting result;

the finite state automaton group includes 24 finite state automata, and any finite state automaton Mᵢ=(Σᵢ, Qᵢ, δᵢ, qᵢ, Fᵢ): the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the [symbol] is a positive integer, and [symbol] ≦24.

In the embodiment, the process of implementing Tibetan sorting through the Tibetan character acquisition module 501, the Tibetan character input module 502, the constituent analysis module 503 and the sorting module 504 is similar to the process provided by the second embodiment of the present invention, and thus will not be repeated redundantly herein.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

### Sixth Embodiment

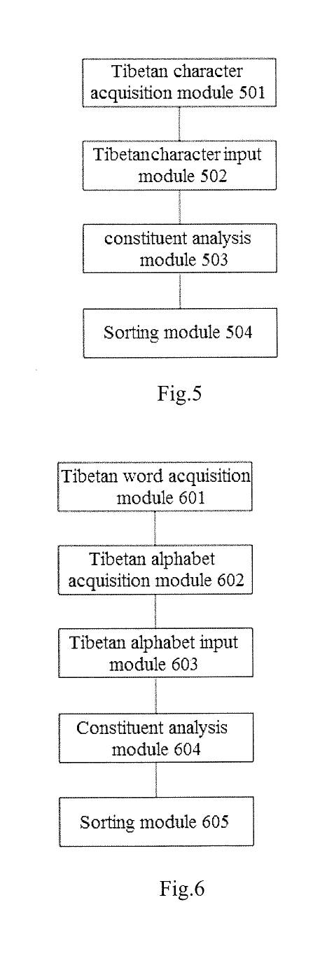

As shown in FIG. 6, the embodiment of the present invention provides a Tibetan sorting device, including:

a Tibetan word acquisition module 601, used for acquiring at least two Tibetan words to be sorted;

a Tibetan character acquisition module 602, connected with the Tibetan word acquisition module and used for respectively acquiring Tibetan characters in the at least two Tibetan words;

a Tibetan character input module 603, connected with the Tibetan character acquisition module and used for respectively using the Tibetan characters in the at least two Tibetan words as the input of a preset finite state automaton group;

a constituent analysis module 604, connected with the Tibetan character input module and used for acquiring the constituents of the Tibetan characters according to a target finite state automaton, when the target finite state automaton in the finite state automaton group determines that the input Tibetan characters are correctly spelled; and

a sorting module 605, connected with the constituent analysis module and used for sorting the at least two Tibetan words according to the constituents of the each Tibetan character in the at least two Tibetan words to acquire a sorting result;

the finite state automaton group includes 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ; and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the [symbol] is a positive integer, and [symbol] ≦24.

In the embodiment, the process of implementing Tibetan sorting through the Tibetan word acquisition module 601 to the sorting module 605 is similar to the process provided by the third embodiment of the present invention, and thus will not be repeated redundantly herein.

The present invention has the following beneficial effects: the Tibetan text to be analyzed is used as the input of the finite state automaton group, and the constituents of the Tibetan characters are acquired according to the target finite state automaton which determines that the Tibetan characters are correct, therefore Tibetan character constituent analysis is achieved, and Tibetan sorting can be further achieved according to the constituents of the Tibetan characters. As the finite state automaton group corresponds to the Tibetan spelling formal grammar, the technical solutions provided by the embodiments of the present invention solve the problem that the existing Tibetan sorting methods have no universality or compatibility, which is inconvenient for the use of automatic computer Tibetan sorting.

The order of the above embodiments is only for the purpose of convenient description, and does not represent the advantages and disadvantages of the embodiments.

Finally, it should be noted that the above embodiments are merely used for illustrating the technical solutions of the present invention, rather than limiting them; although the present invention has been described in detail with reference to the foregoing embodiments, those of ordinary skill in the art should understand that they could still make modifications to the technical solutions recorded in the foregoing embodiments or make equivalent substitutions to a part of technical features therein; and these modifications or substitutions do not make the essence of the corresponding technical solutions depart from the spirit and the scope of the technical solutions of the embodiments of the present invention.

1. A Tibetan character constituent analysis method, comprising:
S10, acquiring a Tibetan text to be analyzed;
S20, using Tibetan characters in the Tibetan text as the input of a preset finite state automaton group; and
S30, acquiring the constituents of the Tibetan characters according to a target finite state automaton, when the target finite state automaton in the finite state automaton group determines that the Tibetan characters in the Tibetan text are correctly spelled;
the finite state automaton group comprises 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the [symbol] is a positive integer, and [symbol] ≦24.

2. The Tibetan character constituent analysis method of claim 1, wherein the step S30 comprises:
S301, acquiring a target Tibetan spelling formal grammar corresponding to the target finite state automaton; and
S302, acquiring the constituents of the Tibetan characters according to the target Tibetan spelling formal grammar.

3. A Tibetan sorting method, comprising:
S10, acquiring at least two Tibetan characters to be sorted;
S20, respectively using the at least two Tibetan characters to be sorted as the input of a preset finite state automaton group;
S30, acquiring the constituents of the Tibetan characters according to a target finite state automaton, when the target finite state automaton in the finite state automaton group determines that the input Tibetan characters are correctly spelled; and
S40, sorting the at least two Tibetan characters according to the constituents of the at least two Tibetan characters to acquire a sorting result;
the finite state automaton group comprises 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ and Fᵢ⊂Qᵢ; and the [symbol] is a positive integer, and [symbol] ≦24.

4. The Tibetan sorting method of claim 3, wherein for any two Tibetan characters in the at least two Tibetan characters, the step S40 comprises:
S401, judging whether the two Tibetan characters conform to a preset constituent rule according to the constituents of the two Tibetan characters; if so, executing S402; otherwise, executing S404;
S402, judging whether the roots of the two Tibetan characters are the same; if so, executing S403; otherwise, executing S404;
S403, sequentially comparing the constituents of the two Tibetan characters according to the sequence of prefixes, superfixes, subfixes, vowels, suffixes and postfixes; executing S405;
S404, sequentially comparing the constituents of the two Tibetan characters according to the sequence of superfixes, prefixes, subfixes, vowels, suffixes and postfixes; executing S405; and
S405, if the comparison result is that the former Tibetan character in the two Tibetan characters is larger than the latter Tibetan character, exchanging the sequence of the two Tibetan characters; and otherwise, keeping the sequence of the two Tibetan characters unchanged.

5. The Tibetan sorting method of claim 4, wherein the 401 comprises:
S4011, acquiring spelling structure serial numbers of the two Tibetan characters according to the constituents of the two Tibetan characters; and
S4012, judging whether the two Tibetan characters conform to the preset constituent rule according to the spelling structure serial numbers of the two Tibetan characters;
the constituent rule comprises:
the spelling structure serial number of the first Tibetan character in the two Tibetan characters belongs to a set {2, 4, 18, 20, 22, 24}, and the spelling structure serial number of the second Tibetan character in the two Tibetan characters belongs to a set {5, 7, 10, 12, 14, 16}; or, the spelling structure serial number of the first Tibetan character in the two Tibetan characters belongs to the set {5, 7, 10, 12, 14, 16}, and the spelling structure serial number of the second Tibetan character in the two Tibetan characters belongs to the set {2, 4, 18, 20, 22, 24}.

6. A Tibetan sorting method, comprising:
S10, acquiring at least two Tibetan words to be sorted;
S20, respectively acquiring Tibetan characters in the at least two Tibetan words;
S30, respectively using the Tibetan characters in the at least two Tibetan words as the input of a preset finite state automaton group;
S40, acquiring the constituents of the Tibetan characters according to a target finite state automaton, when the target finite state automaton in the finite state automaton group determines that the input Tibetan characters are correctly spelled; and
S50, sorting the at least two Tibetan words according to the constituents of the each Tibetan character in the at least two Tibetan words to acquire a sorting result;
the finite state automaton group comprises 24 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the [symbol] is a positive integer, and [symbol] ≦24.

7. The Tibetan sorting method of claim 6, wherein for any two Tibetan words in the at least two Tibetan words, the step S50 comprises:
S501, respectively acquiring first Tibetan characters in the two Tibetan words;
S502, judging whether the two Tibetan characters conform to a preset constituent rule according to the constituents of the Tibetan characters; if so, executing S503; otherwise, executing S505;
S503, judging whether the roots of the Tibetan characters are the same; if so, S504; otherwise, executing S505;
S504, sequentially comparing the constituents of the Tibetan characters according to the sequence of prefixes, superfixes, subfixes, vowels, suffixes and postfixes; executing S506;
S505, sequentially comparing the constituents of the Tibetan characters according to the sequence of superfixes, prefixes, subfixes, vowels, suffixes and postfixes; executing S506; and
S506, if the comparison result is that the Tibetan characters in the former Tibetan word are larger than the corresponding Tibetan characters in the latter Tibetan word, exchanging the sequence of the two Tibetan words; if the comparison result is that the Tibetan characters in the former Tibetan word are smaller than the corresponding Tibetan characters in the latter Tibetan word, keeping the sequence of the two Tibetan words unchanged; and if the comparison result is that the Tibetan characters in the former Tibetan word are equal to the corresponding Tibetan characters in the latter Tibetan word, acquiring the next Tibetan characters in the at least two Tibetan words, and executing S502 to S506 until all the Tibetan characters in the two Tibetan words are completely compared.
